(19) United States
(12) Patent Application Publication
(10) Pub. No.: US 2026/0281391 A1
(43) Pub. Date: Sep. 17, 2026

(54) ADAPTIVE BIT RATE CONTROL WITH LOOK-AHEAD ANALYSIS AND SUBSEQUENT RATE CONTROL REFINEMENT

(71) Applicants: Ximin Zhang, San Jose, CA (US); Yunbiao Wang, Fremont, CA (US); Yi-Jen Chiu, San Jose, CA (US)

(72) Inventors: Ximin Zhang, San Jose, CA (US); Yunbiao Wang, Fremont, CA (US); Yi-Jen Chiu, San Jose, CA (US)

(21) Appl. No.: 19/677,364

(22) Filed: May 14, 2026

(51) Int. Cl. H04N 19/177; H04N 19/124

(52) U.S. Cl. CPC H04N 19/177; H04N 19/124

(57) ABSTRACT

Adaptive rate control for video encoding can be performed using look-ahead analysis and actual encoding feedback. A look-ahead encoding pass can be performed using an adaptive look-ahead quantization parameter (QP) selected based on video resolution and target compression ratio, so that look-ahead statistics better correlate with statistics expected during actual encoding. The look-ahead statistics can be used to classify a group-of-pictures (GOP) according to temporal correlation. The classification can be used to select bit-allocation adjustment ratios and relative QP values for distributing bits and QPs among an anchor frame and subsequent frames of the GOP. An estimated minimum and maximum QP range can be generated and applied to constrain actual encoding QP decisions and prevent excessive QP adjustment. After actual encoding begins, feedback, including actual statistics and/or actual QP, can be used to refine one or more subsequent encoding decisions.

### BACKGROUND

Video compression is a technique for making video files smaller and easier to transmit over the Internet. There are different methods and algorithms for video compression, with different performance and tradeoffs. Video compression involves encoding and decoding. Encoding is the process of transforming (uncompressed) video data into a compressed format. Decoding is the process of restoring video data from the compressed format. An encoder-decoder system is called a codec.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an encoding system and a plurality of decoding systems, according to some examples of the disclosure.

FIG. 2 illustrates an example encoder to encode video frames and output an encoded bitstream, according to some examples of the disclosure.

FIG. 3 illustrates an example decoder to decode an encoded bitstream and output a decoded video, according to some examples of the disclosure.

FIG. 4 illustrates a group-of-pictures, according to some examples of the disclosure.

FIG. 5 illustrates a rate control process, according to some examples of the disclosure.

FIG. 6 illustrates determining a look-ahead quantization parameter, according to some examples of the disclosure.

FIG. 7 illustrates determining an initial bit allocation, according to some examples of the disclosure.

FIG. 8 illustrates determining a temporal correlation classification, according to some examples of the disclosure.

FIG. 9 illustrates determining a bit allocation and a relative quantization parameter value, according to some examples of the disclosure.

FIG. 10 illustrates a further rate control process, according to some examples of the disclosure.

FIG. 11 illustrates a look-ahead pass and an encoding pass, according to some examples of the disclosure.

FIG. 12 illustrates determining and optionally refining a maximum quantization parameter and a minimum quantization parameter, according to some examples of the disclosure.

FIG. 13 illustrates a yet further rate control process, according to some examples of the disclosure.

FIG. 14 illustrates refining the bit allocation and the relative quantization parameter value, according to some examples of the disclosure.

FIG. 15 illustrates a method for encoding a video, according to some examples of the disclosure.

FIG. 16 depicts a block diagram of an example computing device, according to some examples of the disclosure.

### DETAILED DESCRIPTION

### Overview

Video coding or video compression is the process of compressing video data for storage, transmission, and playback. Video compression may involve taking a large amount of raw video data and applying one or more compression techniques to reduce the amount of data needed to represent the video while maintaining an acceptable level of visual quality. In some cases, video compression can offer efficient storage and transmission of video content over limited bandwidth networks.

A video includes one or more (temporal) sequences of video frames or frames. A frame may include an image, or a single still image. A frame may have millions of pixels. For example, a frame for an uncompressed 4K video may have a resolution of 3840×2160 pixels. Pixels may have luma/luminance and chroma/chrominance values. The terms “frame” and “picture” may be used interchangeably. There are several frame types or picture types. I-frames or intra-frames may be the least compressible and do not depend on other frames to decode. I-frames may include scene-change frames. P-frames may depend on data from previous frames to decode and may be more compressible than I-frames. B-frames may depend on data from previous and forward frames to decode and may be more compressible than I-frames and P-frames. Other frame types may include reference B-frames and non-reference B-frames. P-frames and B-frames may be referred to as inter-frames. The order in which I-frames, P-frames, and B-frames are arranged may be referred to as a group-of-pictures (GOP).

As used herein, a GOP refers to a set of video frames that are grouped for purposes of rate control, prediction, bit allocation, and/or QP assignment. A GOP may include an anchor frame and one or more subsequent frames associated with the anchor frame in an encoding order, display order, reference-picture relationship, temporal-layer hierarchy, or other coding structure. A GOP may be implemented as, include, or correspond to a miniGOP, a hierarchical GOP, a portion of a larger GOP, or another subset of frames within a look-ahead window. A miniGOP is a local GOP or subset of frames used as a rate-control decision unit, such as for temporal correlation classification, bit-allocation determination, and relative-QP-value determination. A hierarchical GOP is a GOP or miniGOP in which frames are organized into prediction or temporal layers, so that bit allocation and relative QP values may be distributed among an anchor frame and subsequent frames or layers.

Rate control is a tuning mechanism for controlling video encoding because rate control governs how the encoder spends bits across frames, layers, and time. In various video encoders, the target bitrate or buffer constraint is a starting point. The rate-control process translates that target into frame-level and group-of-pictures-level decisions, including bit allocation, quantization parameter (QP) selection, QP range limits, and inter-frame QP relationships. Small changes in rate-control behavior can materially affect compression efficiency, visual quality, latency, buffer compliance, and worst-frame quality. As a result, rate control functions as a control knob that balances competing objectives, including meeting bitrate and buffer requirements, preserving quality on complex or important frames, avoiding unnecessary bit expenditure on easier content, and adapting to changes in motion, noise, scene complexity, and temporal correlation.

Some rate-control approaches can allocate frame sizes using relatively fixed GOP-position rules or utilize look-ahead statistics that do not predict or match actual encoding behavior. This can lead to quality fluctuation, inefficient bit use, and poor worst-frame quality, particularly for high-bitrate content, noisy content, sudden motion, or scenes whose coding characteristics differ from what a fixed allocation model expects.

To address one or more of these issues, one or more adaptive rate control mechanisms can be implemented using one or more of look-ahead analysis, temporal correlation classification, QP-range control, and actual-encoding feedback.

In some examples, an encoder is triggered to perform a look-ahead encoding pass on a plurality of video frames using a look-ahead QP. Rather than selecting that look-ahead QP as a fixed value for all content, the look-ahead QP can be determined based on one or more of a compression ratio and a resolution associated with the plurality of video frames. In some examples, the look-ahead QP can be determined by indexing a look-up table using a compression-ratio index and/or a resolution index. Utilizing an adaptive look-ahead QP for the look-ahead pass can improve the technical usefulness of the look-ahead pass because the encoded frames generated from the look-ahead encoding pass are more likely to produce statistics that correlate with actual encoding behavior.

In some examples, the rate-control process derives one or more statistics from the plurality of encoded frames generated from the look-ahead encoding pass. These statistics may include one or more of a frame-size related statistic, an intra-coded block statistic, and a skip-coded block statistic. In some examples, the statistics may include a first frame size (or an anchor frame size), an average frame size, a maximum frame size, normalized skip block count, and normalized intra block count. The statistics can provide content-sensitive indicators of coding complexity and prediction effectiveness.

In some examples, the one or more statistics are used to determine a temporal correlation class for a group-of-pictures in the look-ahead encoding pass. The classification can be based on a frame size of an anchor frame of the group-of-pictures and one or more of an average frame size and a maximum frame size of the group-of-pictures. The classification can also be based on an intra percentage, a skip percentage, and one or more threshold pairs associated with candidate temporal correlation classes. The classification process provides a compact and meaningful way to represent how strongly frames in the group-of-pictures are related for temporal prediction and bit-distribution purposes.

In some examples, the process determines one or more of a bit allocation and a relative QP value for one or more frames of the group-of-pictures based on the temporal correlation class.

For bit allocation, the process can retrieve, from a table indexed by the temporal correlation class (and optionally the GOP structure or size), one or more adjustment ratios for the one or more frames and calculate adjusted bit allocations using those adjustment ratios. Adapting the bit allocations to the temporal correlation class allows the bit allocation to emphasize or de-emphasize particular frames or layers of the group-of-pictures based on content-derived temporal correlation rather than relying only on a fixed GOP-position model.

For QP distribution, the process can retrieve, from a table indexed by the temporal correlation class (and optionally the GOP structure or size), a recommended relative QP value for one or more frames of the group-of-pictures and calculate respective QPs for those frames using the recommended relative QP value. The term “relative QP value” captures the relationship among QPs assigned to an anchor frame and subsequent frames or layers. Assigning QP values to different frames in the GOP based on the temporal correlation class supports QP spacing that is coordinated with content-derived temporal correlation rather than relying only on a fixed GOP-position model.

In some examples, the process determines one or more of a minimum QP and a maximum QP for the encoding pass based on an estimated encoding QP and a constant. The estimated encoding QP may be generated by applying a machine-learning model to one or more input features associated with the plurality of encoded frames generated from the look-ahead encoding pass, including one or more of average encoded bits, average syntax bits, average skip percentage, average intra percentage, average peak signal-to-noise ratio, and average target frame size. The machine-learning model implements a learned mapping between look-ahead behavior, target coding conditions, and actual encoding QP behavior. Bounding the QP used in the encoding pass using the minimum QP and maximum QP can prevent overly aggressive QP changes that may otherwise cause quality loss or waste bits when quality is already sufficient.

In some examples, the minimum QP and maximum QP can be updated or refined based on an offset to the estimated encoding QP. The offset is based on a difference between an average QP used in a completed encoding window and an average estimated QP for a corresponding completed look-ahead window. This offset-based adjustment allows the QP range (e.g., defined by the minimum QP and the maximum QP) to track and adapt to systematic mismatch between look-ahead prediction and actual encoding.

In some examples, the process uses actual encoding feedback to refine one or more earlier rate-control decisions. One or more further statistics can be extracted from one or more further encoded frames of the group-of-pictures generated from the encoding pass (using the same or different encoder as the look-ahead pass). A further temporal correlation class can be determined based on those further statistics. The bit allocation and/or relative QP value can then be refined based on the relationship between the original temporal correlation class and the further temporal correlation class.

In some examples, if the temporal correlation class and the further temporal correlation class are different, the process can update one or more of the bit allocation and the relative QP value based on the further temporal correlation class. This provides a correction mechanism when actual encoding reveals that the original look-ahead-derived class did not accurately represent the group-of-pictures.

In some examples, if the classes are the same, the process can change one or more of the bit allocation and the relative QP value based on a comparison between an actual encoding QP of the further encoded frames and a look-ahead QP. For same-class refinement, the bit allocation ratio between layers of the group-of-pictures can be increased, decreased, or maintained depending on whether the actual encoding QP is larger than, smaller than, or the same as the look-ahead QP (respectively). Similarly, the magnitude of the relative QP value between layers of the group-of-pictures can be increased, decreased, or maintained based on whether the actual encoding QP is larger than, smaller than, or the same as the look-ahead QP (respectively). Advantageously, the process fine-tunes the strength of the inter-layer bit allocation and QP distribution using actual encoder behavior.

One or more of these mechanisms form an adaptive rate-control architecture involving one or more of: triggering the encoder to perform a look-ahead encoding pass, driving temporal correlation classification using statistics from the resulting encoded frames, controlling bit allocation and a relative QP value based on the classification, setting minimum and maximum QP constraints based on a machine-learned estimated encoding QP, and refining one or more rate control decisions based on actual encoding feedback. Advantageously, the rate-control process can offer one or more of: better aligning look-ahead predictions with actual encoding behavior, improving robustness to content-dependent changes, reducing quality fluctuations, and providing more efficient bit distribution across frames and layers of a group-of-pictures.

One or more of the contributions can be implemented independently or in any suitable combination depending on encoder complexity, product constraints, and desired adaptation depth. For example, an encoder may implement adaptive look-ahead QP selection to select a look-ahead QP based on one or more of compression ratio and resolution, thereby improving the correlation between statistics derived from a look-ahead encoding pass and behavior expected during an encoding pass. Separately, or in combination, the encoder may determine a temporal correlation class for a group-of-pictures based on one or more statistics and use the temporal correlation class to determine one or more of a bit allocation and a relative QP value for frames of the group-of-pictures. In another implementation, the encoder may determine a minimum QP and/or maximum QP based on an estimated encoding QP, with or without using the temporal correlation classification or class-based bit-allocation and relative-QP tables. In still another implementation, actual-encoding feedback may be used to refine one or more of a temporal correlation class, bit allocation, relative QP value, minimum QP, and maximum QP after encoding begins, with or without using all upstream look-ahead-based determinations. Thus, each contribution may operate as a separate rate-control operation that improves a particular encoder control decision, while two or more contributions may be combined to provide additional adaptation by coordinating one or more of look-ahead QP selection, statistic-based temporal correlation classification, bit allocation, relative QP value determination, QP range control, and feedback-based refinement.

For clarity, the disclosed rate-control techniques expressly contemplate implementation of any one of the four contributions alone, any combination of two of the four contributions, any combination of three of the four contributions, or all four contributions together. Thus, an encoder may implement only adaptive look-ahead QP selection, only temporal-correlation-class-based bit allocation and relative QP value determination, only minimum QP and/or maximum QP determination, or only actual-encoding-feedback-based refinement. The encoder may also implement any pair of these operations, such as adaptive look-ahead QP selection with temporal correlation classification, adaptive look-ahead QP selection with QP range control, adaptive look-ahead QP selection with feedback-based refinement, temporal correlation classification with QP range control, temporal correlation classification with feedback-based refinement, or QP range control with feedback-based refinement. Similarly, the encoder may implement any three of the operations while omitting the remaining operation. For example, an encoder may use adaptive look-ahead QP selection, temporal correlation classification, and feedback-based refinement without QP range control; or may use temporal correlation classification, QP range control, and feedback-based refinement without adaptive look-ahead QP selection. Accordingly, the techniques are not limited to a single integrated pipeline, and each contribution may provide an independent and/or complementary technical improvement to a corresponding encoder control decision while remaining combinable with any subset of the other contributions.

### Video Compression

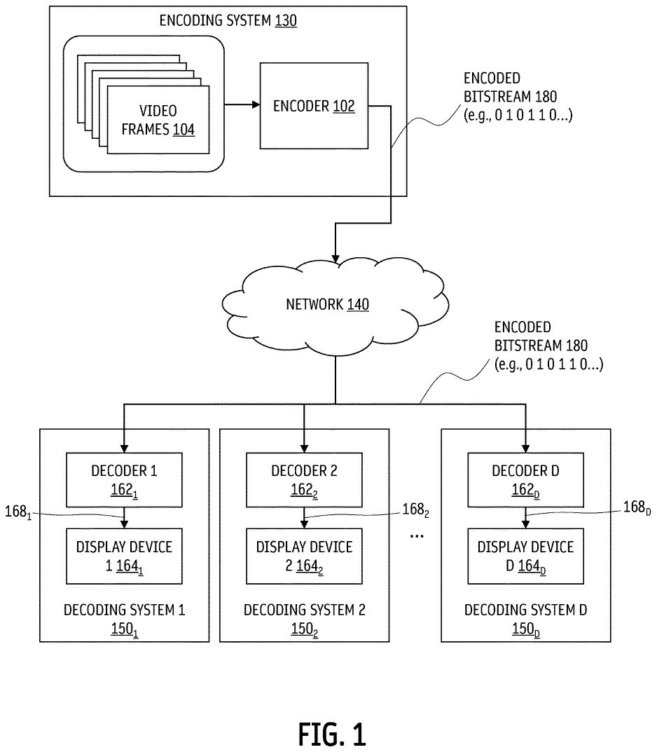

FIG. 1 illustrates encoding system 130 and one or more decoding systems 150_{1 . . . D}, according to some examples of the disclosure.

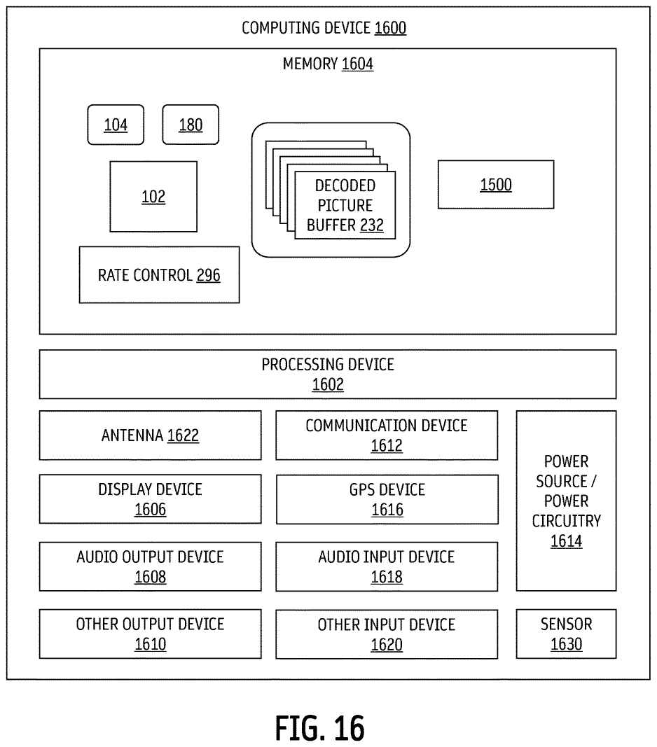

Encoding system 130 may be implemented on computing device 1600 of FIG. 16. Encoding system 130 can be implemented in the cloud or in a data center. Encoding system 130 can be implemented on a device that is used to capture the video. Encoding system 130 can be implemented on a standalone computing system. Encoding system 130 may perform the process of encoding in video compression. Encoding system 130 may receive a video (e.g., uncompressed video, original video, raw video, etc.) comprising a sequence of video frames 104. The video frames 104 may include image frames or images that make up the video. A video may have a frame rate or number of frames per second (FPS) that defines the number of frames per second of video. The higher the FPS, the more realistic and fluid the video looks. Typically, FPS is greater than 24 frames per second for a natural, realistic viewing experience to a human viewer. Examples of video may include a television episode, a movie, a short film, a short video (e.g., less than 15 seconds long), a video capturing gaming experience, computer screen content, video conferencing content, live event broadcast content, sports content, a surveillance video, a video shot using a mobile computing device (e.g., a smartphone), etc. In some cases, video may include a mix or combination of different types of video.

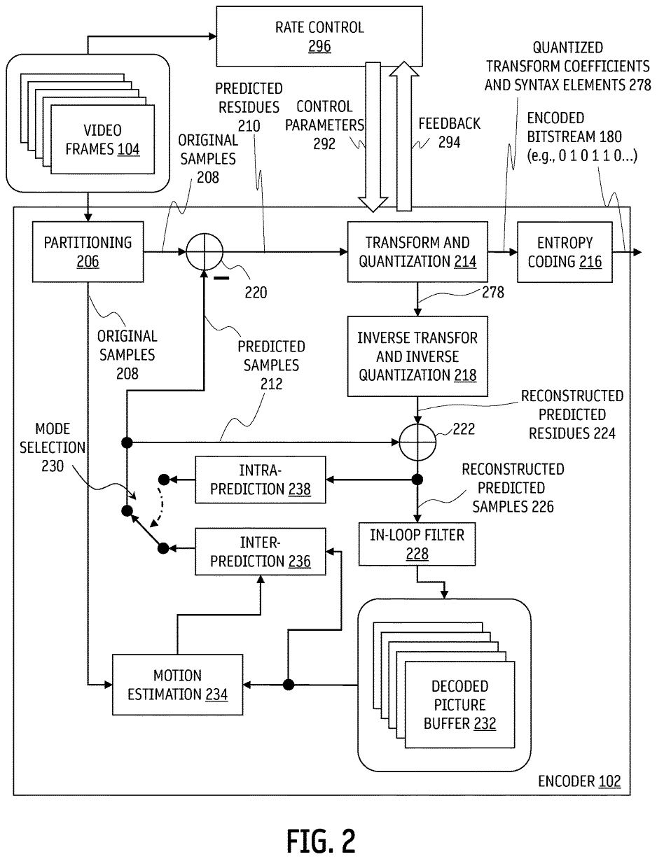

Encoding system 130 may include encoder 102 that receives video frames 104 and encodes video frames 104 into encoded bitstream 180. An example implementation of encoder 102 is illustrated in FIG. 2.

Encoded bitstream 180 may be compressed, meaning that encoded bitstream 180 may be smaller in size than video frames 104. Encoded bitstream 180 may include a series of bits, e.g., having 0's and 1's. Encoded bitstream 180 may have header information, payload information, and footer information, which may be encoded as bits in the bitstream. Header information may provide information about one or more of: the format of encoded bitstream 180, the encoding process implemented in encoder 102, the parameters of encoder 102, and metadata of encoded bitstream 180. For example, header information may include one or more of: resolution information, frame rate, aspect ratio, color space, etc. Payload information may include data representing content of video frames 104, such as samples, frames, symbols, syntax elements, etc. For example, payload information may include bits that encode one or more of motion predictors, transform coefficients, prediction modes, and quantization levels of video frames 104. Footer information may indicate an end of the encoded bitstream 180. Footer information may include other information, including one or more of: checksums, error correction codes, and signatures. The format of encoded bitstream 180 may vary depending on the specification of the encoding and decoding process, i.e., the codec.

Encoded bitstream 180 may include packets, where encoded video data and signaling information may be packetized. One example format is the Open Bitstream Unit (OBU), which is used in AV1 encoded bitstreams. An OBU may include a header and a payload. The header can include information about the OBU, such as information that indicates the type of OBU. Examples of OBU types may include sequence header OBU, frame header OBU, metadata OBU, temporal delimiter OBU, and tile group OBU. Payloads in OBUs may carry quantized transform coefficients and syntax elements that may be used in the decoder to properly decode the encoded video data to regenerate video frames.

Encoded bitstream 180 may be transmitted to one or more decoding systems 150_{1 . . . D}, via network 140. Network 140 may be the Internet. Network 140 may include one or more of: cellular data networks, wireless data networks, wired data networks, cable Internet networks, fiber optic networks, satellite Internet networks, etc.

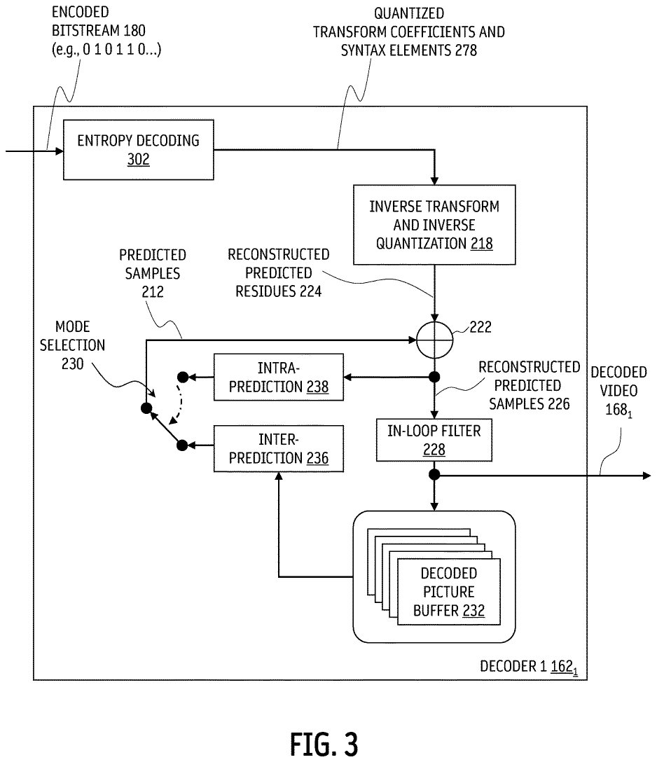

D number of decoding systems 150_{1 . . . D} are illustrated. At least one of the decoding systems 150_{1 . . . D} may be implemented on computing device 1600 of FIG. 16. Examples of systems 150_{1 . . . D} may include personal computers, mobile computing devices, gaming devices, augmented reality devices, mixed reality devices, virtual reality devices, televisions, etc. Each one of decoding systems 150_{1 . . . D} may perform the process of decoding in video compression. Each one of decoding systems 150_{1 . . . D} may include a decoder (e.g., decoder 1 . . . D 162_{1 . . . D}), and one or more display devices (e.g., display device 1 . . . D 164_{1 . . . D}). An example implementation of a decoder, e.g., decoder 1 162₁, is illustrated in FIG. 3.

For example, decoding system 1 1501 may include decoder 1 1621 and a display device 1 164₁. Decoder 1 162₁ may implement a decoding process of video compression. Decoder 1 162₁ may receive encoded bitstream 180 and produce decoded video 168₁. Decoded video 168₁ may include a series of video frames, which may be a version or a reconstructed version of video frames 104 encoded by encoding system 130. Display device 1 164₁ may output the decoded video 168₁ for display to one or more human viewers or users of decoding system 1 150₁.

For example, decoding system 2 1502 may include decoder 2 1622 and a display device 2 164₂. Decoder 2 162₂ may implement a decoding process of video compression. Decoder 2 162₂ may receive encoded bitstream 180 and produce decoded video 168₂. Decoded video 168₂ may include a series of video frames, which may be a version or a reconstructed version of video frames 104 encoded by encoding system 130. Display device 2 164₂ may output the decoded video 168₂ for display to one or more human viewers or users of decoding system 2 150₂.

For example, decoding system D 150D may include decoder D 162D and a display device D 164_{D}. Decoder D 162_{D} may implement a decoding process of video compression. Decoder D 162_{D} may receive encoded bitstream 180 and produce decoded video 168_{D}. Decoded video 168_{D} may include a series of video frames, which may be a version or a reconstructed version of video frames 104 encoded by encoding system 130. Display device D 164_{D} may output the decoded video 168_{D} for display to one or more human viewers or users of decoding system D 150_{D}.

### Video Encoder

FIG. 2 illustrates encoder 102 to encode video frames and output an encoded bitstream, according to some examples of the disclosure. Encoder 102 may include one or more of: signal processing operations and data processing operations, including inter- and intra-prediction, transform, quantization, in-loop filtering, and entropy coding. Encoder 102 may include a reconstruction loop involving inverse quantization, and inverse transformation to guarantee that the decoder would see the same reference blocks and frames. Encoder 102 may receive video frames 104 and encode video frames 104 into encoded bitstream 180. Encoder 102 may include one or more of partitioning 206, transform and quantization 214, inverse transform and inverse quantization 218, in-loop filter 228, motion estimation 234, inter-prediction 236, intra-prediction 238, and entropy coding 216.

Partitioning 206 may divide a frame in video frames 104 into blocks of pixels. In some cases, a frame may be partitioned into one or more blocks by partitioning 206. Blocks may be used for block-based compression. Blocks may have sizes that are much smaller, such as 512×512 pixels, 256×256 pixels, 128×128 pixels, 64×64 pixels, 32×32 pixels, 16×16 pixels, 8×8 pixels, 4×4 pixels, etc. A block may include a square or rectangular region of a frame. Various video compression techniques may use different terminology for the blocks or different partitioning structures for creating the blocks. In some video compression techniques, a frame may be partitioned into Coding Tree Units (CTUs). A CTU may be divided (separately for luma and chroma components) into Coding Tree Blocks (CTBs). A CTB can have a size of 64×64 pixels, 32×32 pixels, or 16×16 pixels. A CTB can be divided into Coding Units (CUs). A CU can be divided into Prediction Units (PUs) and/or discrete cosine transforms (DCT) Transform Units (TUs).

Different codecs may allow different variable ranges of block sizes. In one codec, a frame may be partitioned by partitioning 206 into blocks of size 128×128 or 64×64 pixels. In some cases, a frame may be partitioned by partitioning 206 into blocks of size 32×32 pixels or 16×16 pixels. In some cases, a frame may be partitioned by partitioning 206 into blocks of 256×256 or 512×512 pixels. Large blocks may be referred to as superblocks. Partitioning 206 may further divide each superblock using a multi-way partition tree structure. In some cases, a partition of a superblock can be recursively divided further by partitioning 206 using the multi-way partition tree structure (e.g., down to 4×4 size blocks). In another codec, a frame may be partitioned by partitioning 206 into CTUs of size 128×128 pixels. Partitioning 206 may divide a CTU using a quadtree partitioning structure into four CUs. Partitioning 206 may further recursively divide a CU using the quadtree partitioning structure. Partitioning 206 may (further) subdivide a CU using a multi-type tree structure (e.g., a quadtree, a binary tree, or a ternary tree structure). A smallest CU may have a size of 4×4. Partitioning 206 may output original samples 208, e.g., as blocks of pixels.

Intra-prediction 238 may predict samples of a block from reconstructed predicted samples of previously encoded spatial neighboring/reference blocks of the same frame. Intra-prediction 238 may receive reconstructed predicted samples 226 (of previously encoded spatial neighbor blocks of the same frame). Reconstructed predicted samples 226 may be generated by summer 222 from reconstructed predicted residues 224 and predicted samples 212. Intra-prediction 238 may determine a suitable predictor for predicting the samples from reconstructed predicted samples of previously encoded spatial neighboring/reference blocks of the same frame. Intra-prediction 238 may generate predicted samples 212 using the suitable predictor. Intra-prediction 238 may output or identify the neighboring/reference block and a predictor used in generating the predicted samples 212. The identified neighboring/reference block and predictor may be encoded in the encoded bitstream 180 to enable a decoder to reconstruct a block using the same neighboring/reference block and predictor. In one codec, intra-prediction 238 may support a number of diverse predictors, e.g., 56 different predictors. Some predictors, e.g., directional predictors, may capture different spatial redundancies in directional textures. Pixel values of a block can be predicted using a directional predictor in intra-prediction 238 by extrapolating pixel values of a neighboring/reference block along a certain direction. Intra-prediction 238 of different codecs may support different sets of predictors to exploit different spatial patterns within the same frame. Examples of predictors may include direct current (DC), planar, Paeth, smooth, smooth vertical, smooth horizontal, recursive-based filtering modes, chroma-from-luma, intra-block copy, color palette, multiple-reference line, intra-sub-partition, matrix-based intra-prediction (matrix coefficients may be defined by offline training using neural networks), wide-angle prediction, cross-component linear model, template matching, etc. In some cases, intra-prediction 238 may perform block-prediction, where a predicted block may be produced from a reconstructed neighboring/reference block of the same frame using a vector. Optionally, an interpolation filter of a certain type may be applied to the predicted block to blend pixels of the predicted block. Pixel values of a block can be predicted using a vector compensation process in intra-prediction 238 by translating a neighboring/reference block (within the same frame) according to the vector (and optionally applying an interpolation filter to the neighboring/reference block) to produce predicted samples 212. Intra-prediction 238 may output or identify the vector applied in generating predicted samples 212. In some codecs, intra-prediction 238 may encode (1) a residual vector generated from the applied vector and a vector predictor candidate, and (2) information that identifies the vector predictor candidate, rather than encoding the applied vector itself. Intra-prediction 238 may output or identify an interpolation filter type applied in generating predicted samples 212.

Motion estimation 234 and inter-prediction 236 may predict samples of a block from samples of previously encoded frames, e.g., reference frames in decoded picture buffer 232. Motion estimation 234 and inter-prediction 236 may perform motion compensation, which may involve identifying a suitable reference block and a suitable motion predictor (or vector) for a block and optionally an interpolation filter to be applied to the reference block. Motion estimation 234 may receive original samples 208 from partitioning 206. Motion estimation 234 may receive samples from decoded picture buffer 232 (e.g., samples of previously encoded frames or reference frames). Motion estimation 234 may use a number of reference frames for determining one or more suitable motion predictors. A motion predictor may include a reference block and a motion vector that can be applied to generate a motion-compensated block or predicted block. Motion predictors may include motion vectors that capture the movement of blocks between frames in a video. Motion estimation 234 may output or identify one or more reference frames and one or more suitable motion predictors. Inter-prediction 236 may apply the one or more suitable motion predictors determined in motion estimation 234 and one or more reference frames to generate predicted samples 212. The identified reference frame(s) and motion predictor(s) may be encoded in the encoded bitstream 180 to enable a decoder to reconstruct a block using the same reference frame(s) and motion predictor(s). In one codec, motion estimation 234 may implement single reference frame prediction mode, where a single reference frame with a corresponding motion predictor is used for inter-prediction 236. Motion estimation 234 may implement compound reference frame prediction mode where two reference frames with two corresponding motion predictors are used for inter-prediction 236. In one codec, motion estimation 234 may implement techniques for searching and identifying good reference frame(s) that can yield the most efficient motion predictor. The techniques in motion estimation 234 may include searching for good reference frame(s) candidates spatially (within the same frame) and temporally (in previously encoded frames). The techniques in motion estimation 234 may include searching a deep spatial neighborhood to find a spatial candidate pool. The techniques in motion estimation 234 may include utilizing temporal motion field estimation mechanisms to generate a temporal candidate pool. The techniques in motion estimation 234 may use a motion field estimation process. After temporal and spatial candidates are ranked, a suitable motion predictor may be determined. In one codec, inter-prediction 236 may support a number of diverse motion predictors. Examples of predictors may include geometric motion vectors (complex, non-linear motion), warped motion compensation (affine transformations that capture non-translational object movements), overlapped block motion compensation, advanced compound prediction (compound wedge prediction, difference-modulated masked prediction, frame distance-based compound prediction, and compound inter-intra prediction), dynamic spatial and temporal motion vector referencing, affine motion compensation (capturing higher-order motion such as rotation, scaling, and shearing), adaptive motion vector resolution modes, geometric partitioning modes, bidirectional optical flow, prediction refinement with optical flow, bi-prediction with weights, extended merge prediction, etc. Optionally, an interpolation filter of a certain type may be applied to the predicted block to blend pixels of the predicted block. Pixel values of a block can be predicted using the motion predictor/vector determined in a motion compensation process in motion estimation 234 and inter-prediction 236 and optionally applying an interpolation filter. In some cases, inter-prediction 236 may perform motion compensation, where a predicted block may be produced from a reconstructed reference block of a reference frame using the motion predictor/vector. Inter-prediction 236 may output or identify the motion predictor/vector applied in generating predicted samples 212. In some codecs, inter-prediction 236 may encode (1) a residual vector generated from the applied vector and a vector predictor candidate, and (2) information that identifies the vector predictor candidate, rather than encoding the applied vector itself. Inter-prediction 236 may output or identify an interpolation filter type applied in generating predicted samples 212.

Mode selection 230 may be informed by components such as motion estimation 234 to determine whether inter-prediction 236 or intra-prediction 238 may be more efficient for encoding a block (thus making an encoding decision). Inter-prediction 236 may output predicted samples 212 of a predicted block. Inter-prediction 236 may output a selected predictor and a selected interpolation filter (if applicable) that may be used to generate the predicted block. Intra-prediction 238 may output predicted samples 212 of a predicted block. Intra-prediction 238 may output a selected predictor and a selected interpolation filter (if applicable) that may be used to generate the predicted block. Regardless of the mode, predicted residues 210 may be generated by subtractor 220 by subtracting original samples 208 from predicted samples 212. In some cases, predicted residues 210 may include residual vectors from inter-prediction 236 and/or intra-prediction 238.

Transform and quantization 214 may receive predicted residues 210. Predicted residues 210 may be generated by subtractor 220 that takes original samples 208 and subtracts predicted samples 212 to output predicted residues 210. Predicted residues 210 may be referred to as the prediction error of intra-prediction 238 and inter-prediction 236 (e.g., error between the original samples and predicted samples 212). Prediction error has a smaller range of values than the original samples and can be coded with fewer bits in encoded bitstream 180. Transform and quantization 214 may include one or more of transforming and quantizing. Transforming may include converting the predicted residues 210 from the spatial domain to the frequency domain. Transforming may include applying one or more transform kernels. Examples of transform kernels may include horizontal and vertical forms of DCT, asymmetrical discrete sine transform (ADST), flip ADST, and identity transform (IDTX), multiple transform selection, low-frequency non-separable transform, subblock transform, non-square transforms, DCT-VIII, discrete sine transform VII (DST-VII), discrete wavelet transform (DWT), etc. Transforming may convert the predicted residues 210 into transform coefficients. Quantizing may quantize the transformed coefficients, e.g., by reducing the precision of the transform coefficients. Quantizing may include using quantization matrices (e.g., linear and non-linear quantization matrices). The elements in the quantization matrix can be larger for higher frequency bands and smaller for lower frequency bands, which means that the higher frequency coefficients are more coarsely quantized, and the lower frequency coefficients are more finely quantized. Quantizing may include dividing each transform coefficient by a corresponding element in the quantization matrix and rounding to the nearest integer. Effectively, the quantization matrices may implement different QPs for different frequency bands and chroma planes and can use spatial prediction. A suitable quantization matrix can be selected and signaled for each frame and encoded in encoded bitstream 180. Transform and quantization 214 may output quantized transform coefficients and syntax elements 278 that indicate the coding modes and parameters used in the encoding process implemented in encoder 102.

Inverse transform and inverse quantization 218 may apply the inverse operations performed in transform and quantization 214 to produce reconstructed predicted residues 224 as part of a reconstruction path to produce decoded picture buffer 232 for encoder 102. Inverse transform and inverse quantization 218 may receive quantized transform coefficients and syntax elements 278. Inverse transform and inverse quantization 218 may perform one or more inverse quantization operations, e.g., applying an inverse quantization matrix, to obtain the unquantized/original transform coefficients. Inverse transform and inverse quantization 218 may perform one or more inverse transform operations, e.g., inverse transform (e.g., inverse DCT, inverse DWT, etc.), to obtain reconstructed predicted residues 224. A reconstruction path is provided in encoder 102 to generate reference blocks and frames, which are stored in decoded picture buffer 232. The reference blocks and frames may match the blocks and frames to be generated in the decoder. The reference blocks and frames are used as reference blocks and frames by motion estimation 234, inter-prediction 236, and intra-prediction 238.

In-loop filter 228 may implement filters to smooth out artifacts introduced by the encoding process in encoder 102 (e.g., processing performed by partitioning 206 and transform and quantization 214). In-loop filter 228 may receive reconstructed predicted samples 226 from summer 222 and output frames to decoded picture buffer 232. Examples of in-loop filters may include Cross-Component Sample Offset (CCSO) filter, guided detail filter (GDF), constrained low-pass filter, directional deringing filter, edge-directed conditional replacement filter, loop restoration filter, Wiener filter, self-guided restoration filters, constrained directional enhancement filter (CDEF), Luma Mapping with Chroma Scaling (LMCS), Sample Adaptive Offset (SAO) filter, Adaptive Loop Filter (ALF), cross-component ALF, low-pass filter, deblocking filter, etc. For example, applying a deblocking filter across a boundary between two blocks can resolve blocky artifacts caused by the Gibbs phenomenon. In some examples, in-loop filter 228 may fetch data from a frame buffer having reconstructed predicted samples 226 of various blocks of a video frame. Encoder 102 may determine whether to apply an in-loop filter or not. Encoder 102 may determine one or more suitable filters that achieve good visual quality and/or one or more suitable filters that suitably remove the artifacts introduced by the encoding process in encoder 102. After applying the one or more (suitable) filters, in-loop filter 228 may write (filtered) reconstructed samples to a frame buffer, such as decoded picture buffer 232.

Entropy coding 216 may receive quantized transform coefficients and syntax elements 278 (e.g., referred to herein as symbols) and perform entropy coding. Entropy coding 216 may generate and output encoded bitstream 180. Entropy coding 216 may exploit statistical redundancy and apply lossless algorithms to encode the symbols and produce a compressed bitstream, e.g., encoded bitstream 180. Entropy coding 216 may implement some version of arithmetic coding. Different versions may have different pros and cons. In one codec, entropy coding 216 may implement (symbol-to-symbol) adaptive multi-symbol arithmetic coding. In another codec, entropy coding 216 may implement context-based adaptive binary arithmetic coder (CABAC). Binary arithmetic coding differs from multi-symbol arithmetic coding. Binary arithmetic coding encodes only a bit at a time, e.g., having either a binary value of 0 or 1. Binary arithmetic coding may first convert each symbol into a binary representation (e.g., using a fixed number of bits per symbol). Handling just a binary value of 0 or 1 can simplify computation and reduce complexity. Binary arithmetic coding may assign a probability to each binary value (e.g., a chance of the bit having a binary value of 0 and a chance of the bit having a binary value of 1). Multi-symbol arithmetic coding performs encoding for an alphabet having at least two or three symbol values and assigns a probability to each symbol value in the alphabet. Multi-symbol arithmetic coding can encode more bits at a time, which may result in a fewer number of operations for encoding the same amount of data. Multi-symbol arithmetic coding can require more computation and storage (since probability estimates may be updated for every element in the alphabet). Maintaining and updating probabilities (e.g., cumulative probability estimates) for each possible symbol value in multi-symbol arithmetic coding can be more complex (e.g., complexity grows with alphabet size). Multi-symbol arithmetic coding is not to be confused with binary arithmetic coding, as the two different entropy coding processes are implemented differently and can result in different encoded bitstreams for the same set of quantized transform coefficients and syntax elements 278.

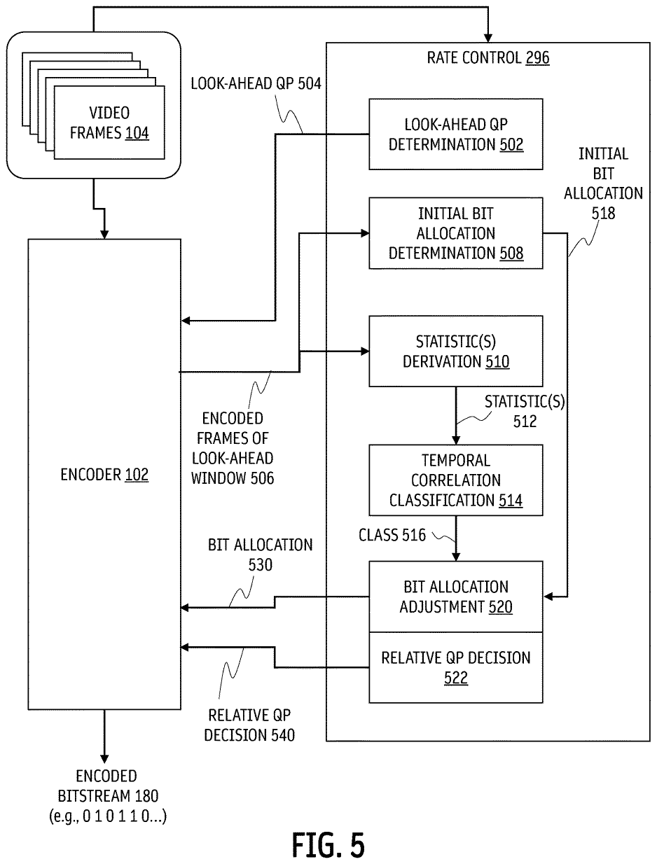

Rate control 296 can operate with encoder 102 (or one or more instances of encoder 102) to determine control parameters 292 that influence how encoder 102 encodes video frames 104. One or more operations of rate control 296 are described and illustrated in FIGS. 5-15.

Control parameters 292 can include one or more rate-control decisions, such as a look-ahead QP, a bit allocation, a relative QP value, a minimum QP, a maximum QP, or a suitable encoding control parameter. Rate control 296 can provide control parameters 292 to one or more portions of encoder 102, such as transform and quantization 214, entropy coding 216, partitioning 206, mode selection 230, motion estimation 234, intra-prediction 238, inter-prediction 236, or other encoder processes that affect bitrate, quality, prediction structure, and encoded bitstream generation.

In some examples, rate control 296 may use feedback 294 to determine control parameters 292. Feedback 294 can include information generated by or associated with a look-ahead encoding pass, an encoding pass, or both. For example, feedback 294 can include one or more statistics derived from encoded frames, such as frame-size related statistics, intra-coded block statistics, skip-coded block statistics, syntax-bit statistics, actual encoding QP values, estimated encoding QP values, or suitable encoder state information. Rate control 296 can use feedback 294 to determine or refine control parameters 292, including determining a temporal correlation class for a group-of-pictures, determining bit allocation and relative QP values for frames of the group-of-pictures, constraining QP decisions using minimum QP and maximum QP values, and refining subsequent encoding decisions based on actual encoding behavior.

### Video Decoder

FIG. 3 illustrates decoder 1 162₁ to decode an encoded bitstream and output a decoded video, according to some examples of the disclosure. Decoder 1 162₁ may include one or more of: signal processing operations and data processing operations, including entropy decoding, inverse transform, inverse quantization, inter and intra-prediction, in-loop filtering, etc. Decoder 1 162₁ may have signal and data processing operations that mirror the operations performed in the encoder. Decoder 1 162₁ may apply signal and data processing operations that are signaled in encoded bitstream 180 to reconstruct the video. Decoder 1 162₁ may receive encoded bitstream 180 and generate and output decoded video 168₁ having a plurality of video frames. The decoded video 168₁ may be provided to one or more display devices for display to one or more human viewers. Decoder 1 162₁ may include one or more of entropy decoding 302, inverse transform and inverse quantization 218, in-loop filter 228, inter-prediction 236, and intra-prediction 238. Some of the functionalities are previously described and used in the encoder, such as encoder 102 of FIG. 2.

Entropy decoding 302 may decode the encoded bitstream 180 and output symbols that were coded in the encoded bitstream 180. The symbols may include quantized transform coefficients and syntax elements 278. Entropy decoding 302 may reconstruct the symbols from the encoded bitstream 180.

Inverse transform and inverse quantization 218 may receive quantized transform coefficients and syntax elements 278 and perform operations that are performed in the encoder. Inverse transform and inverse quantization 218 may output reconstructed predicted residues 224. Summer 222 may receive reconstructed predicted residues 224 and predicted samples 212 and generate reconstructed predicted samples 226. Inverse transform and inverse quantization 218 may output syntax elements 278 having signaling information for informing/instructing/controlling operations in decoder 1 162₁, such as mode selection 230, intra-prediction 238, inter-prediction 236, and in-loop filter 228.

Depending on the prediction modes signaled in the encoded bitstream 180 (e.g., as syntax elements in quantized transform coefficients and syntax elements 278), intra-prediction 238 or inter-prediction 236 may be applied to generate predicted samples 212.

Summer 222 may sum predicted samples 212 of a decoded reference block and reconstructed predicted residues 224 to produce reconstructed predicted samples 226 of a reconstructed block. For intra-prediction 238, the decoded reference block may be in the same frame as the block that is being decoded or reconstructed. For inter-prediction 236, the decoded reference block may be in a different (reference) frame in decoded picture buffer 232.

Intra-prediction 238 may determine a reconstructed vector based on a residual vector and a selected vector predictor candidate. Intra-prediction 238 may apply a reconstructed predictor or vector (e.g., in accordance with signaled predictor information) to the reconstructed block, which may be generated using a decoded reference block of the same frame. Intra-prediction 238 may apply a suitable interpolation filter type (e.g., in accordance with signaled interpolation filter information) to the reconstructed block to generate predicted samples 212.

Inter-prediction 236 may determine a reconstructed vector based on a residual vector and a selected vector predictor candidate. Inter-prediction 236 may apply a reconstructed predictor or vector (e.g., in accordance with signaled predictor information) to a reconstructed block, which may be generated using a decoded reference block of a different frame from decoded picture buffer 232. Inter-prediction 236 may apply a suitable interpolation filter type (e.g., in accordance with signaled interpolation filter information) to the reconstructed block to generate predicted samples 212.

In-loop filter 228 may receive reconstructed predicted samples 226. In-loop filter 228 may apply one or more filters signaled in the encoded bitstream 180 to the reconstructed predicted samples 226. In-loop filter 228 may output decoded video 168₁.

### An Illustration of a Group-of-Pictures

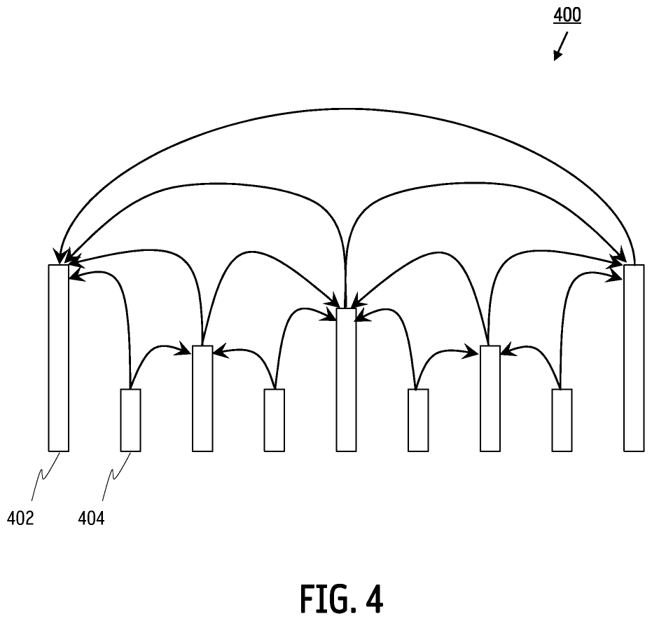

FIG. 4 illustrates GOP 400, according to some examples of the disclosure. GOP 400 can include a plurality of frames grouped for purposes of prediction, rate control, bit allocation, and QP assignment. GOP 400 can correspond to a miniGOP, a hierarchical GOP, a portion of a larger GOP, or another subset of frames within a look-ahead window. The plurality of frames can include anchor frame 402 and one or more subsequent frames associated with anchor frame 402, such as frame 404, according to an encoding order, display order, reference-picture relationship, temporal-layer hierarchy, or other coding structure.

As illustrated by the arrows between frames, GOP 400 can have a hierarchical prediction structure in which one or more frames are predicted from one or more other frames of GOP 400. Anchor frame 402 can serve as a reference or higher-level frame for one or more subsequent frames, and the one or more subsequent frames can be arranged at different prediction or temporal layers. In some examples, anchor frame 402 may be the first frame of GOP 400 in an encoding order and may use a lower QP or receive a larger bit allocation than one or more subsequent frames because the coding quality of anchor frame 402 can affect the prediction quality of dependent frames.

Fixed bit allocation and fixed relative QP relationships are often inadequate for GOP 400 because frames within GOP 400 may have different prediction roles, temporal-layer positions, motion characteristics, texture complexity, and dependency relationships. For example, anchor frame 402 may affect prediction quality for multiple subsequent frames, while different subsequent frames may contribute differently to coding efficiency and visual quality. A fixed allocation or fixed relative QP pattern may therefore over-allocate bits to frames that are easy to encode or under-allocate bits to frames that are important for prediction, which can cause inefficient bit use, quality fluctuation, or degraded quality in dependent frames.

In some examples, GOP 400 can be used as a rate-control decision unit. For example, an encoder can perform a look-ahead encoding pass on a plurality of video frames that includes, overlaps with, or is used to identify or represent GOP 400. In the context of GOP 400, content-adaptive rate control can use statistics derived from the look-ahead encoding pass to determine a temporal correlation class for GOP 400 and then select bit allocation and relative QP values that better match the illustrated prediction structure. This allows rate control to distribute bits and QPs among anchor frame 402 and one or more subsequent frames based on actual or predicted coding behavior, rather than relying solely on fixed frame positions within GOP 400.

### Illustrative Rate Control Processes

FIG. 5 illustrates a rate control process, according to some examples of the disclosure Rate control 296 can trigger encoder 102 to perform a look-ahead encoding pass on video frames 104 using look-ahead QP 504.

In some examples, look-ahead QP determination 502 can determine look-ahead QP 504 based on one or more properties associated with video frames 104, such as compression ratio and/or resolution. In some examples, look-ahead QP determination 502 can determine look-ahead QP 504 by indexing a look-up table using one or more of compression ratio index and resolution index. Selecting look-ahead QP 504 in this manner can improve correlation between statistics generated during the look-ahead encoding pass and coding behavior expected during a later encoding pass and can improve the reliability of rate-control decisions derived from look-ahead analysis.

In some examples, encoder 102 can output encoded frames of look-ahead window 506 to rate control 296.

In some examples, initial bit allocation determination 508 can determine initial bit allocation 518 based on one or more of encoded frames of look-ahead window 506, a target bit budget, a buffer condition, and a target frame size. In some examples, initial bit allocation 518 can provide an initial distribution of bits among frames before class-based adjustment is applied.

In some examples, statistic(s) derivation 510 can derive statistic(s) 512 from encoded frames of look-ahead window 506. Statistic(s) 512 can include one or more of: frame-size related statistic, intra-coded block statistic, skip-coded block statistic, syntax-bit statistic, QP-related statistic, or another statistic indicative of coding complexity, prediction behavior, or temporal dependency.

In some examples, temporal correlation classification 514 can determine class 516 for a group-of-pictures in a look-ahead encoding pass based on statistic(s) 512. In some examples, temporal correlation classification 514 can assign class 516 based on a frame size of an anchor frame of a group-of-pictures and one or more of the average frame size of a group-of-pictures and the maximum frame size of a group-of-pictures. In some examples, temporal correlation classification 514 can also assign class 516 based on intra percentage, skip percentage, and one or more threshold pairs associated with candidate temporal correlation classes. Class 516 can represent a content-adaptive measure of temporal correlation among frames or layers of a group-of-pictures, which allows rate control 296 to distinguish coding structures that may benefit from different bit-allocation and QP relationships.

In some examples, bit allocation adjustment 520 can determine bit allocation 530 for one or more frames of a group-of-pictures based on class 516 and initial bit allocation 518. For example, bit allocation adjustment 520 can retrieve, from a table indexed by class 516, one or more adjustment ratios for one or more frames of a group-of-pictures and can calculate adjusted bit allocations using the one or more adjustment ratios.

In some examples, relative QP decision 522 can determine relative QP decision 540 based on class 516, such as by retrieving a recommended relative QP value from a table indexed by class 516 and calculating respective QPs for one or more frames of a group-of-pictures using the recommended relative QP value.

Bit allocation 530 and/or relative QP decision 540 can be provided to encoder 102 so that encoder 102 can perform an encoding pass using one or more of bit allocation 530 and relative QP decision 540.

By using statistic(s) 512 to determine class 516 and using class 516 to determine bit allocation 530 and/or relative QP decision 540, rate control 296 can adapt encoding decisions to content characteristics of a group-of-pictures rather than relying only on fixed frame-position rules. Performing content-adaptive rate control can reduce under-allocation of bits to frames that are important for prediction, reduce over-allocation of bits to frames that are less important or easier to encode, and improve consistency of quality among frames of a group-of-pictures. Rate control 296 can coordinate one or more of look-ahead QP selection, initial bit allocation, statistic-based temporal correlation classification, class-based bit-allocation adjustment, and relative-QP-value determination before or during encoding of a group-of-pictures.

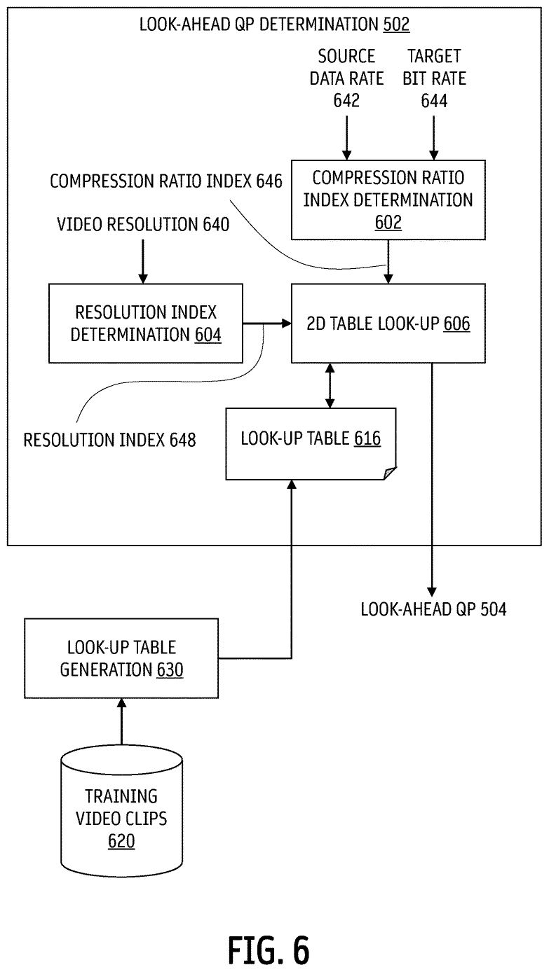

FIG. 6 illustrates determining a look-ahead quantization parameter, according to some examples of the disclosure. Look-ahead QP determination 502 can be included in rate control 296 and can determine look-ahead QP 504 used by encoder 102 during a look-ahead encoding pass. Look-ahead QP 504 can be different from QP values used during a later encoding pass, and can be selected to cause encoded frames generated from the look-ahead encoding pass to produce one or more statistics that are predictive of actual encoding behavior. Look-ahead QP determination 502 can include one or more of: compression ratio index determination 602, resolution index determination 604, two-dimensional (2D) table look-up 606, and look-up table 616.

In some examples, compression ratio index determination 602 can receive source data rate 642 and target bit rate 644 and determine compression ratio index 646. Source data rate 642 can represent an amount of source video data to be encoded, such as an uncompressed or estimated input data rate based on frame size, frame rate, bit depth, chroma format, or another source-video characteristic. Target bit rate 644 can represent a desired encoded bit rate, target average frame size, or another rate-control target. Compression ratio index determination 602 can determine a compression ratio based on a relationship between source data rate 642 and target bit rate 644, and can map the compression ratio to compression ratio index 646 corresponding to one of multiple compression-ratio ranges.

In some examples, resolution index determination 604 can receive video resolution 640 and determine resolution index 648. Video resolution 640 can include, for example, frame width, frame height, luma sample count, picture size, or a resolution class associated with video frames 104. Resolution index determination 604 can map video resolution 640 to resolution index 648 corresponding to one of multiple resolution ranges or resolution categories. By using resolution index 648 in addition to compression ratio index 646, look-ahead QP determination 502 can account for situations where a look-ahead QP that produces useful statistics for one resolution or compression condition may not produce similarly useful statistics for another resolution or compression condition.

In some examples, look-up table generation 630 can generate look-up table 616 using training video clips 620. Training video clips 620 can include representative video content having one or more of different resolutions, bit rates, compression ratios, motion characteristics, texture characteristics, noise levels, and scene-change characteristics. In some examples, look-up table generation 630 can encode training video clips 620 using multiple candidate look-ahead QP values and can evaluate how well statistics generated at each candidate look-ahead QP correlate with statistics or QP behavior observed during actual encoding. Look-up table generation 630 can then store, in look-up table 616, look-ahead QP values selected for corresponding combinations of compression-ratio ranges and resolution ranges.

In some examples, look-up table 616 can store entries indexed by compression ratio index 646 and resolution index 648. Each entry can identify look-ahead QP 504 or information usable to derive look-ahead QP 504. In some examples, look-up table 616 can be generated offline and stored for online use by rate control 296. In other examples, look-up table 616 can be updated, tuned, replaced, or supplemented based on additional training data, encoder configuration, codec type, product configuration, or empirical encoding results. Look-up table 616 can provide an implementation-efficient mechanism for selecting look-ahead QP 504 without performing a full search during real-time encoding.

In some examples, look-up table 616 may store look-ahead QP 504 as a function of compression ratio index 646 and resolution index 648. Compression ratio index 646 may be derived from a compression ratio, such as source data rate 642 divided by target bit rate 644. Resolution index 648 may be derived from video resolution 640. An example of look-up table 616 is as follows:

| | Low | Medium | High |
|---|---|---|---|
| Resolution | compression | compression | compression |
| index 648 | ratio | ratio | ratio |
| R0 - lower | QP 26 | QP 32 | QP 38 |
| resolution | | | |
| R1 - medium | QP 24 | QP 30 | QP 36 |
| resolution | | | |
| R2 - higher | QP 22 | QP 28 | QP 34 |
| resolution | | | |

Look-up table 616 (e.g., such as the example above) may store look-ahead QP 504 values indexed by compression ratio index 646 and resolution index 648. In the example above, compression ratio index 646 may indicate whether the target encoding condition corresponds to a low, medium, or high compression ratio, and resolution index 648 may indicate whether video resolution 640 corresponds to a lower, medium, or higher resolution range. The stored QP values are illustrative, and actual entries may be generated by look-up table generation 630 using training video clips 620, empirical encoder testing, or other calibration data. In some examples, higher compression-ratio indices correspond to progressively larger look-ahead QP values because greater compression generally uses coarser quantization. Resolution index 648 provides an additional dimension so that the selected look-ahead QP 504 can be adapted to resolution-dependent encoding behavior. In some examples, lower resolution indices correspond to progressively larger look-ahead QP values.

In look-up table generation 630, multiple candidate look-ahead QP values may be tested for training video clips 620 across different compression-ratio and resolution buckets. For each bucket, a candidate look-ahead QP may be selected based on correlation between statistics generated during the look-ahead encoding pass and statistics or QP behavior observed during an encoding pass. Thus, look-up table 616 may not necessarily store a QP that optimizes look-ahead visual quality. Rather, look-up table 616 may store a QP that improves the usefulness or predictiveness of look-ahead statistics for downstream rate-control decisions.

In some examples, 2D table look-up 606 can receive compression ratio index 646 and resolution index 648 and can index look-up table 616 to determine look-ahead QP 504. In some examples, 2D table look-up 606 can select an entry of look-up table 616. In other examples, 2D table look-up 606 can perform interpolation, clipping, range limiting, default-value selection, or fallback selection when compression ratio index 646 or resolution index 648 falls outside a stored table range. 2D table look-up 606 can output look-ahead QP 504 to rate control 296 and/or encoder 102 for use during the look-ahead encoding pass.

Selecting look-ahead QP 504 based on compression ratio index 646 and resolution index 648 can improve later rate-control decisions because statistic(s) derived from encoded frames of the look-ahead window can better represent coding behavior expected during the encoding pass. For example, if look-ahead QP 504 is too low, the look-ahead encoding pass may spend too many bits and may produce statistics that overstate coding quality or temporal predictability. If look-ahead QP 504 is too high, the look-ahead encoding pass may produce distorted or sparse statistics that understate the usefulness of prediction or frame importance. Resolution-aware and compression-ratio-aware selection of look-ahead QP 504 can reduce these mismatches.

In some examples, look-up table 616 may be a one-dimensional look-up table indexed by only one of compression ratio index 646 or resolution index 648, such as when the other parameter is fixed, unavailable, omitted, or otherwise not used for selecting look-ahead QP 504.

In some examples, look-ahead QP determination 502 can support downstream operations of rate control 296. For example, encoded frames generated using look-ahead QP 504 can be used to derive one or more statistics, determine a temporal correlation class for a group-of-pictures in the look-ahead encoding pass, determine one or more of a bit allocation and a relative QP value for one or more frames of the group-of-pictures, and/or determine or refine a minimum QP and maximum QP. By improving correlation between look-ahead statistics and actual encoding behavior, look-ahead QP determination 502 can improve robustness of temporal-correlation classification, reduce inappropriate bit allocation, improve selection of relative QP values, and reduce later correction required from actual-encoding feedback.

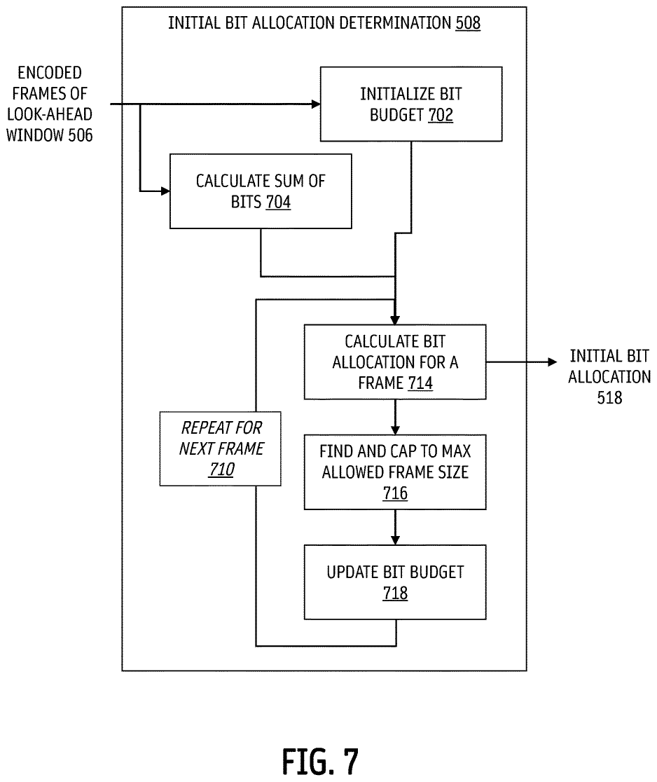

FIG. 7 illustrates determining an initial bit allocation, according to some examples of the disclosure. Initial bit allocation determination 508 can determine initial bit allocation 518 using encoded frames of look-ahead window 506. Initial bit allocation 518 can represent an initial distribution of bits for one or more frames, e.g., before one or more later operations such as temporal-correlation-class-based adjustment, relative QP value determination, minimum QP and maximum QP determination, and/or feedback-based refinement. In some examples, initial bit allocation determination 508 can use frame sizes generated during a look-ahead encoding pass as predictors of relative coding complexity for frames in a look-ahead window, group-of-pictures, miniGOP, hierarchical GOP, or other rate-control unit.

In some examples, initialize bit budget 702 can initialize a bit budget for one or more frames to be allocated. In some examples, initialize bit budget 702 can determine a bit budget based on a target average frame size and a number of frames in a look-ahead window associated with encoded frames of look-ahead window 506. For example, initial bit budget 702 can determine or calculate:

$$Bit\_budget = N * Average\_FrameSize$$

N represents a number of frames considered for allocation and Average_FrameSize represents a target average frame size derived from a target bit rate.

In some examples, when N is less than a number of frames corresponding to a specified temporal interval, such as one second, initialize bit budget 702 can extend the allocation window for budget calculation purposes. Within initialize bit budget 702, when the number of frames available in look-ahead window 506 is less than a number of frames corresponding to a predetermined temporal duration, such as one second, initial bit allocation determination 508 can determine the bit budget using an effective budgeting window corresponding to the predetermined temporal duration rather than only the available look-ahead frames. For example, if the look-ahead window associated with encoded frames of look-ahead window 506 includes N available frames and one second corresponds to N_eff frames, where N<N_eff, initialize bit budget 702 can determine or calculate:

$$Bit\_budget = N\_eff * Average\_FrameSize$$

The calculation can stabilize the budget over a longer temporal horizon. Implementing the adjustment to the allocation window in these scenarios can reduce instability that might otherwise occur when an allocation decision is based on too few frames.

In some examples, calculate sum of bits 704 can calculate a sum of bits represented by encoded frames of look-ahead window 506. For example, calculate sum of bits 704 can determine or calculate:

$$Sum\_Com = Bits [ 1 ] + … + Bits [ N ]$$

Bits[i] represents encoded bits for frame i produced during the look-ahead encoding pass.

In some examples, when the look-ahead window associated with encoded frames of look-ahead window 506 has fewer frames than a desired temporal window, calculate sum of bits 704 can estimate additional frame contributions using a frame size from the look-ahead window associated with encoded frames of look-ahead window 506, such as Bits[N], or another representative frame-size value. Within calculate sum of bits 704, when the look-ahead window associated with encoded frames of look-ahead window 506 includes fewer frames than the effective budgeting window, initial bit allocation determination 508 can extend the sum-of-bits calculation using estimated frame sizes for the missing portion of the effective budgeting window. For example, calculate sum of bits 704 can determine or calculate:

$$Sum\_Com = Bits [ 1 ] + … + Bits [ N ] + ( N\_eff - N ) * Bits [ N ]$$

Bits[N] is a last available look-ahead frame size. In some examples, Bits[N] can represent the average of the previously encoded frames size in a group-of-pictures. The calculation can ensure that proportional allocation is normalized against a one-second or other predetermined-duration estimate rather than an overly short look-ahead sample. Sum of bits 704 can provide a normalization basis that reflects relative bit demand observed during the look-ahead encoding pass.

In some examples, calculate bit allocation for a frame 714 can determine an initial bit allocation for a current frame based on the initialized bit budget and the calculated sum of bits. In some examples, calculate bit allocation for a frame 714 can determine or calculate:

$$Bit\_Allocate [ i ] = Bit\_budget * Bits [ i ] / Sum\_Com$$

$$For a first frame ( i = 1 ) , this can be expressed as Bit\_Allocate [ 1 ] = Bit\_budget * Bits [ 1 ] / Sum\_Com .$$

In this manner, a frame that consumes a larger portion of look-ahead encoded bits can receive a larger initial allocation, while a frame that consumes a smaller portion of look-ahead encoded bits can receive a smaller initial allocation. This proportional allocation can provide a content-sensitive starting point before additional class-based adjustment is performed.

In some examples, find and cap to max allowed frame size 716 can determine whether bit allocation calculated for a frame should be limited based on an applicable maximum allowed frame size. Maximum allowed frame size can be determined based on one or more of buffer constraints, hypothetical reference decoder constraints, channel constraints, coded picture buffer fullness, target latency, maximum frame size, and a suitable rate-control constraint. In some examples, when Bit_Allocate[i] exceeds the maximum allowed frame size, find and cap to max allowed frame size 716 can replace Bit_Allocate[i] with the maximum allowed frame size. This cap can help maintain buffer compliance and can reduce a risk that a single frame consumes an excessive portion of available bits. In some examples, find and cap to max allowed frame size 716 is optional.

In some examples, update bit budget 718 can update the bit budget after allocation of a current frame. In some examples, update bit budget 718 can update a rolling budget according to:

$$Bit\_budget [ next ] = Bit\_budget [ previous ] - Bit\_Allocate [ previous ] + Average\_FrameSize$$

This update can subtract bits allocated to a completed or current frame and add back a target average frame size for a next frame. Updating bit budget 718 in this manner can allow initial bit allocation determination 508 to operate over a moving or rolling allocation window while maintaining consistency with a target bit rate.

In some examples, repeat for next frame 710 can cause initial bit allocation determination 508 to repeat allocation operations for one or more additional frames. For example, after update bit budget 718 updates the bit budget, initial bit allocation determination 508 can execute operations in calculate bit allocation for a frame 714, (optionally) find and cap to max allowed frame size 716, and update bit budget 718 for a next frame in an encoding order, display order, look-ahead-window order, or other rate-control order. In some examples, repeat for next frame 710 can continue until initial bit allocation 518 has been determined for all frames in a group-of-pictures or another allocation unit.

In some examples, initial bit allocation 518 can include respective initial bit allocations for one or more frames. Initial bit allocation 518 can be provided to another rate-control operation, such as bit allocation adjustment 520, which may adjust initial bit allocation 518 based on a temporal correlation class, one or more adjustment ratios, and/or a GOP structure. Initial bit allocation 518 can also be provided to encoder 102 directly or indirectly for use in encoding one or more frames, such as when class-based adjustment is omitted, simplified, disabled, or not applicable. In some examples, initial bit allocation determination 508 can operate independently or as part of a larger rate-control pipeline.

In some examples, initial bit allocation determination 508 can provide one or more technical advantages. Because initial bit allocation 518 can be based on encoded frame sizes from look-ahead window 506, allocation can reflect relative coding complexity indicated by the look-ahead encoding pass rather than only a fixed frame position. Because calculated bit allocations can be normalized using a sum of bits associated with look-ahead window 506, relative frame-size differences observed during the look-ahead encoding pass can be translated into frame-level rate-control targets. Because calculated allocations can be capped based on a maximum allowed frame size and updated using a rolling bit budget, initial bit allocation determination 508 can balance look-ahead-based complexity estimation with buffer or rate constraints. In some examples, initial bit allocation determination 508 can produce a more reliable starting allocation that can be used directly or further processed by later temporal-correlation-class-based bit allocation, relative QP value determination, and feedback-based refinement operations.

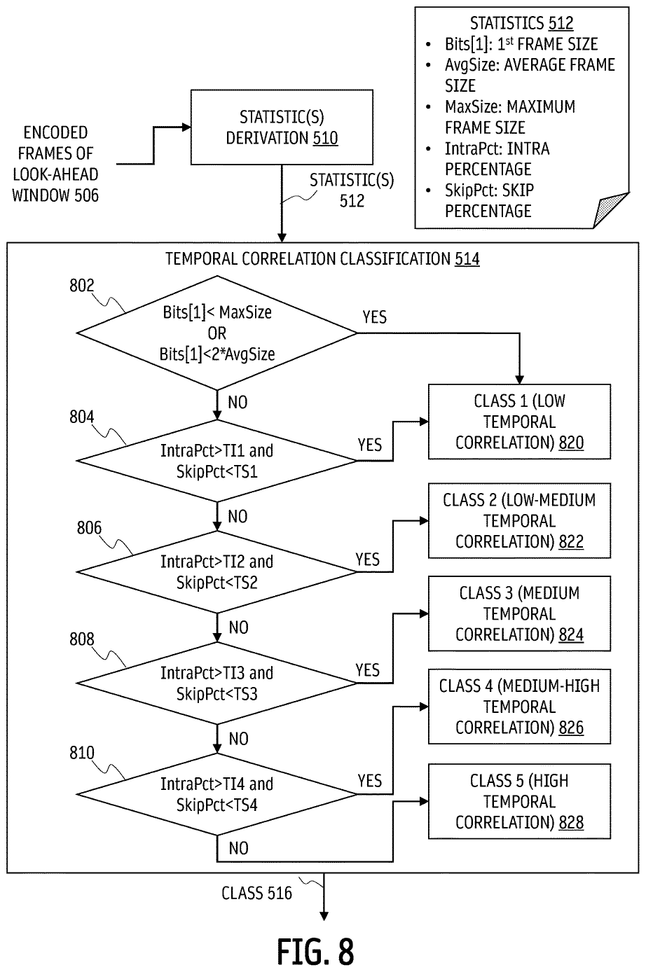

FIG. 8 illustrates determining a temporal correlation classification, according to some examples of the disclosure. Statistic(s) derivation 510 can receive encoded frames of look-ahead window 506 and derive statistic(s) 512 for use by temporal correlation classification 514. In some examples, statistic(s) 512 can include one or more frame-size-related statistics and prediction-mode-related statistics, such as one or more of Bits[1], AvgSize, MaxSize, IntraPct, and SkipPct. Bits[1] can represent a frame size of a first frame of a group-of-pictures, such as an anchor frame in an encoding order. AvgSize can represent an average frame size of the group-of-pictures, and MaxSize can represent a maximum frame size of the group-of-pictures. IntraPct can represent an intra percentage, such as an area-normalized percentage of intra-coded blocks, and SkipPct can represent a skip percentage, such as an area-normalized percentage of skip-coded blocks.

In some examples, statistic(s) derivation 510 can derive statistic(s) 512 by parsing encoded frames of look-ahead window 506 and identifying frames of a group-of-pictures to be classified by temporal correlation classification 514. For a group-of-pictures having M frames, statistic(s) derivation 510 can determine a frame-size value for each frame as Bits[i], where Bits[i] represents the number of encoded bits generated for frame i during the look-ahead encoding pass. Statistic(s) derivation 510 can determine frame-size-related statistics, such as Bits[1], AvgSize, and MaxSize.

Bits[1] represents the frame size of a first frame, such as an anchor frame.

$$AvgSize = \frac{1}{M} * {\sum }_{i = 1}^{M} Bits [ i ]$$

$$Max Size = max ( Bits [ i ] ) for i = 1 … M$$

In some examples, statistic(s) derivation 510 can derive one or more prediction-mode-related statistics from coding decisions, syntax elements, block modes, coding-unit modes, prediction-unit modes, or other information generated during the look-ahead encoding pass. For example, statistic(s) derivation 510 can count one or more of blocks, coding units, prediction units, superblocks, coding tree units, or other coding regions that are coded using intra prediction to determine an intra-coded block statistic. In one example, statistic(s) derivation 510 can calculate an intra percentage as IntraPct[i]=IntraArea[i]/CodedArea[i]. IntraArea[i] represents an area or number of samples associated with intra-coded regions in frame i. CodedArea[i] represents a coded area of frame i. In another example, IntraPct[i]=IntraBlocks[i]/TotalBlocks[i].

In some examples, statistic(s) derivation 510 can count one or more of blocks, coding units, prediction units, superblocks, coding tree units, or other coding regions that are coded using skip mode to determine a skip-coded block statistic. In one example, statistic(s) derivation 510 can calculate a skip percentage as SkipPct[i]=SkipArea[i]/CodedArea[i]. SkipArea[i] represents an area or number of samples associated with skip-coded regions in frame i. In another example, SkipPct[i]=SkipBlocks [i]/TotalBlocks[i]. Area-normalized percentages can be useful because frames or regions with different partitioning structures can be compared using a common scale.

In some examples, statistic(s) 512 can derive one or more per-frame statistics, group-level statistics, and statistics derived from selected frames of the group-of-pictures. For example, IntraPct and SkipPct used by temporal correlation classification 514 can correspond to values for the first frame, values for a second frame in encoding order, averages across two or more selected frames, weighted averages across selected frames, maximum or minimum values across selected frames, or another representative value derived from encoded frames of look-ahead window 506. In one example, IntraPct=w1*IntraPct[1]+w2*IntraPct[2] and SkipPct=w1*SkipPct[1]+w2*SkipPct[2], where w1 and w2 are weighting factors. In another example, temporal correlation classification 514 can use IntraPct[1], SkipPct[1], IntraPct[2], and SkipPct[2] separately.

In some examples, statistic(s) derivation 510 can output statistic(s) 512 in a form usable by temporal correlation classification 514. For example, statistic(s) 512 can include one or more of Bits[1], AvgSize, MaxSize, IntraPct, and SkipPct, as illustrated. These values can enable temporal correlation classification 514 to evaluate both frame-size distribution and prediction-mode behavior. Frame-size distribution can indicate whether the first frame has a size relationship consistent with a particular temporal dependency pattern, while intra percentage and skip percentage can indicate whether frames are relying more heavily on intra coding or temporal prediction.

In some examples, statistic(s) derivation 510 can derive statistic(s) 512 directly from encoded frame data (e.g., encoded frames of look-ahead window 506), coding logs, syntax information, mode-decision information, or side information generated during the look-ahead encoding pass. Statistic(s) derivation 510 can drive the relevant frame sizes and coding-mode counts from encoder-side look-ahead processing. Statistic(s) 512 can allow rate control 296 to obtain useful temporal-correlation indicators with relatively low computational overhead.

In some examples, statistic(s) derivation 510 can improve rate control because statistic(s) 512 reflect behavior observed during the look-ahead encoding pass rather than relying only on fixed frame positions within a group-of-pictures. Frame-size statistics can indicate relative coding demand, intra-coded block statistics can indicate weaker temporal prediction or scene complexity, and skip-coded block statistics can indicate stronger temporal prediction or redundancy. Temporal correlation classification 514 can use these statistics to classify the group-of-pictures and support later determination of bit allocation and relative QP values.

In some examples, temporal correlation classification 514 can determine class 516 based on statistic(s) 512. Class 516 can indicate a temporal correlation class for a group-of-pictures in a look-ahead encoding pass. In some examples, lower class values can indicate lower temporal correlation and higher class values can indicate higher temporal correlation. Temporal correlation classification 514 can convert look-ahead statistics, e.g., statistic(s) 512, into a compact class value that rate control 296 can use to determine one or more of bit allocation and relative QP value for frames of the group-of-pictures.

At decision 802, temporal correlation classification 514 can compare Bits[1] to one or more frame-size statistics of the group-of-pictures. For example, decision 802 can determine whether Bits[1]<MaxSize (whether Bits[1] is less than MaxSize) and/or whether Bits[1]<2*AvgSize (whether Bits[1] is less than twice the AvgSize). When the condition is satisfied, temporal correlation classification 514 can assign the GOP to class 1 820, corresponding to low temporal correlation. This test can identify cases in which the first frame or anchor frame is not sufficiently dominant in size relative to other frames of the group-of-pictures, such as when another frame in the middle of the group-of-pictures is larger due to a scene change, sudden motion, high motion, or other localized complexity, or when the first frame is not at least about twice the average frame size. In such cases, the first frame is less likely to carry a strong prediction burden for subsequent frames across the group-of-pictures, and temporal correlation classification 514 can initially assign the group-of-pictures to class 1 820, corresponding to low temporal correlation.

When decision 802 is not satisfied, temporal correlation classification 514 can evaluate intra percentage and/or skip percentage against one or more threshold pairs associated with candidate temporal correlation classes.

At decision 804, temporal correlation classification 514 can determine whether IntraPct and SkipPct satisfy a first threshold pair (TI1 and TS1), such as whether IntraPct exceeds threshold TI1 and SkipPct is less than threshold TS1. When decision 804 is satisfied, temporal correlation classification 514 can assign the GOP to class 1 820, corresponding to low temporal correlation. The first threshold pair can identify group-of-pictures behavior associated with low temporal correlation, such as relatively high intra coding and relatively low skip coding.

At decision 806, temporal correlation classification 514 can determine whether IntraPct and SkipPct satisfy a second threshold pair (TI2 and TS2), such as whether IntraPct exceeds threshold TI2 and SkipPct is less than threshold TS2. When decision 806 is satisfied, temporal correlation classification 514 can assign the GOP to class 2 822, corresponding to low-medium temporal correlation.

At decision 808, temporal correlation classification 514 can determine whether IntraPct and SkipPct satisfy a third threshold pair (TI3 and TS3), such as whether IntraPct exceeds threshold TI3 and SkipPct is less than threshold TS3. When decision 808 is satisfied, temporal correlation classification 514 can assign the GOP to class 3 824, corresponding to medium temporal correlation.

At decision 810, temporal correlation classification 514 can determine whether IntraPct and SkipPct satisfy a fourth threshold pair (TI4 and TS4), such as whether IntraPct exceeds threshold TI4 and SkipPct is less than threshold TS4. When decision 810 is satisfied, temporal correlation classification 514 can assign the GOP to class 4 826, corresponding to medium-high temporal correlation.

When none of the threshold comparisons results in assignment of class 1 820, class 2 822, class 3 824, or class 4 826, temporal correlation classification 514 can assign the GOP to class 5 828, corresponding to high temporal correlation. Thresholds TI1-TI4 and TS1-TS4 can be predetermined, empirically determined, codec-dependent, content-dependent, or adjusted based on training or calibration data.

In the illustrated threshold cascade, intra thresholds may be ordered such that TI1>TI2>TI3>TI4, and skip thresholds may be ordered such that TS1<TS2<TS3<TS4. This ordering allows temporal correlation classification 514 to first identify low-correlation cases having relatively high intra percentage and relatively low skip percentage, and then progressively identify higher temporal correlation classes as the intra percentage decreases and/or the skip percentage increases. The numerical threshold values may be empirically selected, codec-dependent, resolution-dependent, bitrate-dependent, content-dependent, or generated by training or calibration, and the values shown above are illustrative rather than limiting.

| Candidate | Intra | Skip | |
|---|---|---|---|
| class | threshold | threshold | Example interpretation |
| Class 1 | TI1 = 40% | TS1 = 10% | very high intra and very low skip → low |
| | | | temporal correlation |
| Class 2 | TI2 = 30% | TS2 = 20% | high intra or low skip → low-medium |
| | | | temporal correlation |
| Class 3 | TI3 = 20% | TS3 = 35% | moderate intra or moderate-low skip → |
| | | | medium temporal correlation |
| Class 4 | TI4 = 10% | TS4 = 50% | some intra or not-yet-high skip → medium- |
| | | | high temporal correlation |
| Class 5 | default | default | relatively low intra and relatively high skip |
| | | | → high temporal correlation |

In some examples, intra percentage and skip percentage can be useful indicators of temporal correlation. A relatively high intra percentage may indicate that frames or blocks are being coded without relying heavily on temporal prediction, which can suggest weaker temporal correlation. A relatively high skip percentage may indicate that prediction from other frames is effective and that little or no residual information is needed for many blocks, which can suggest stronger temporal correlation. By considering intra percentage and/or skip percentage, temporal correlation classification 514 can characterize group-of-pictures behavior more accurately than a classification based only on frame position.

Class 516, as assigned by temporal correlation classification 514, can be provided to downstream rate-control operations. For example, class 516 can be used to retrieve one or more adjustment ratios for determining a bit allocation for one or more frames of the group-of-pictures. Class 516 can be used to retrieve a recommended relative QP value and calculate respective QPs for one or more frames of the group-of-pictures using the recommended relative QP value. In some examples, class 516 can be used together with a GOP structure, miniGOP structure, hierarchical GOP structure, temporal-layer structure, or encoding order to determine how bits and QP relationships should be distributed among an anchor frame and subsequent frames.

In some examples, temporal correlation classification 514 can improve rate control because fixed rate control decisions, e.g., bit allocation and fixed relative QP relationships, may not reflect actual prediction behavior within a group-of-pictures. For example, when temporal correlation is high, the coding quality of an anchor frame or lower-layer frame may have a greater influence on subsequent dependent frames, and rate control 296 may benefit from assigning a different bit allocation or relative QP relationship than would be used for a low-correlation group-of-pictures. Conversely, when temporal correlation is low, allocating excessive bits to an anchor frame may provide less benefit to subsequent frames. Class 516 allows rate control 296 to adapt bit allocation and relative QP value decisions to statistics derived from look-ahead encoding rather than relying only on a fixed frame-position pattern.

In some examples, temporal correlation classification 514 can be implemented independently or in combination with other rate-control operations. For example, temporal correlation classification 514 can use statistic(s) 512 generated from a look-ahead encoding pass performed using an adaptive look-ahead QP or can use statistic(s) 512 generated using another look-ahead QP selection technique. Class 516 can be used to determine bit allocation without determining a relative QP value, to determine a relative QP value without adjusting bit allocation, or to determine both bit allocation and relative QP value. In some examples, class 516 can also be compared with a further temporal correlation class derived from actual-encoding statistics to support feedback-based refinement of one or more of bit allocation and relative QP value.

Temporal correlation classification 514 illustrates one example implementation, and other implementations may be used. In some examples, temporal correlation classification 514 may classify a group-of-pictures using only frame-size-related statistics, only intra-coded block statistics, only skip-coded block statistics, or any suitable combination of such statistics. In other examples, temporal correlation classification 514 may use one or more of weighted averages, statistics, per-frame values, values from an anchor frame and one or more subsequent frames, temporal-layer-specific values, empirically tuned thresholds, codec-specific thresholds, machine-learning-based classification, rule-based classification, and a look-up table indexed by one or more statistics. Accordingly, temporal correlation classification 514 is not limited to the particular decision sequence shown, and may use any suitable classification technique that maps statistic(s) 512 derived from encoded frames of look-ahead window 506 to class 516 for use in determining bit allocation and/or relative QP values.

Temporal correlation classification 514 is shown as an illustrative implementation, and other classification configurations may be used depending on codec design, GOP structure, encoder configuration, training data, or desired granularity. For example, temporal correlation classification 514 may use more or fewer candidate temporal correlation classes, different threshold values, different threshold ordering, different logical combinations of intra percentage and skip percentage, or different statistics than those illustrated. In some examples, temporal correlation classification 514 may use more or fewer than five temporal correlation classes, may use a different number of threshold pairs, and may use different threshold values or threshold ordering to map statistic(s) 512 to class 516. In some examples, one implementation may use four threshold pairs to assign five classes, as shown, while another implementation may use two threshold pairs to assign three classes, or five threshold pairs to assign six classes. In some examples, one implementation may implement a look-up table or machine-learning classifier that maps one or more of frame-size-related statistics, intra-coded block statistics, and skip-coded block statistics to a temporal correlation class. The threshold pairs may be empirically selected, codec-dependent, resolution-dependent, profile-dependent, bit-rate-dependent, GOP-structure-dependent, content-dependent, or generated by training or calibration. Accordingly, temporal correlation classification 514 is not limited to the particular thresholds, number of classes, or decision sequence shown, so long as statistic(s) 512 are used to determine class 516 for use in determining one or more of bit allocation and relative QP value.

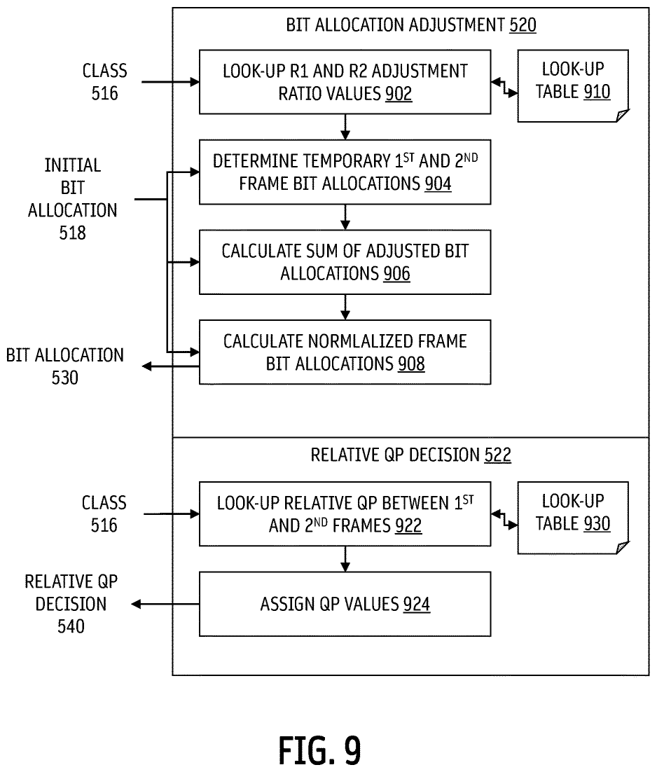

FIG. 9 illustrates determining a bit allocation and a relative quantization parameter value, according to some examples of the disclosure. Bit allocation adjustment 520 can receive class 516 and optionally initial bit allocation 518. Bit allocation adjustment 520 can determine bit allocation 530 for one or more frames of a group-of-pictures. Relative QP decision 522 can receive class 516 and can determine relative QP decision 540 for one or more frames of the group-of-pictures. Bit allocation adjustment 520 and relative QP decision 522 can be performed together, as shown, or one of bit allocation adjustment 520 and relative QP decision 522 can be performed without the other, depending on encoder configuration, rate-control mode, or implementation constraints.

In some examples, look-up R1 and R2 adjustment ratio values 902 of bit allocation adjustment 520 can retrieve one or more adjustment ratios from look-up table 910 based on class 516. In some examples, look-up table 910 can be indexed by class 516 and, optionally, one or more additional parameters, such as GOP structure and/or size, miniGOP structure and/or size, hierarchical layer structure and/or size, coding order, frame type, temporal-layer configuration, or encoder configuration. Adjustment ratio values R1 and R2 can correspond to respective adjustment ratios for a first frame and a second frame of the group-of-pictures, such as an anchor frame and a subsequent frame in encoding order. In some examples, adjustment ratio values R1 and R2 can be positive, negative, or zero, thereby increasing, decreasing, or maintaining corresponding frame allocations before normalization.

In some examples, look-up table 910 can store different adjustment ratio values for different temporal correlation classes. For example, one class may correspond to adjustment ratio values that place relatively more bits on an anchor frame or lower temporal layer, while another class may correspond to adjustment ratio values that produce a flatter allocation across frames or layers. In some examples, higher temporal correlation may justify stronger allocation emphasis on an anchor frame or reference frame because the quality of that frame may influence prediction quality of subsequent dependent frames. In lower temporal correlation cases, stronger anchor-frame emphasis may provide less benefit, and look-up table 910 can store adjustment ratio values that reduce or avoid such emphasis.

In some examples, look-up table 910 may store larger positive adjustment ratio values for higher temporal correlation classes. For example, for a high temporal correlation class, R1 may be a positive value, such as +0.20 or +0.30, to increase the temporary bit allocation of the first frame or anchor frame, and R2 may be a smaller positive value, such as +0.10 or +0.15, to increase the temporary bit allocation of the second frame when the second frame also has prediction importance. For lower temporal correlation classes, R1 and R2 may be smaller positive values, zero, or negative values, because increasing the first or second frame allocation may provide less benefit when subsequent frames are not strongly predicted from those frames. After these temporary adjustments, the adjusted allocations may be normalized to preserve the total bit budget of the group-of-pictures.

| Temporal | Example R1 for | Example R2 | |
|---|---|---|---|
| correlation | 1st frame/ | for 2nd | |
| class | anchor frame | frame | Interpretation |
| Class 1: low | 0.00 or −0.05 | 0.00 or −0.05 | Avoid or reduce special emphasis |
| correlation | | | because anchor quality is less |
| | | | likely to benefit subsequent frames |
| Class 2: low- | +0.05 | 0.00 | Slight anchor emphasis |
| medium | | | |
| correlation | | | |
| Class 3: medium | +0.10 | +0.05 | Moderate emphasis on first and |
| correlation | | | possibly second frame |
| Class 4: | +0.20 | +0.10 | Stronger emphasis on prediction- |
| medium-high | | | important frames |
| correlation | | | |
| Class 5: high | +0.30 | +0.15 | Strong emphasis because |
| correlation | | | anchor/reference quality may |
| | | | propagate to dependent frames |

In some examples, look-up table 910 can be populated through one or more of: empirical testing, offline training, encoder tuning, and rule-based design. For example, training video clips having one or more different temporal correlation characteristics, motion levels, scene-change behavior, noise levels, resolutions, bit rates, and GOP structures can be encoded using different candidate adjustment ratio values for R1 and R2. For each temporal correlation class, a pair of R1 and R2 values can be selected based on a coding-performance objective, such as reducing worst-frame quality degradation, reducing quality fluctuation, improving bitrate accuracy, improving buffer compliance, or improving rate-distortion performance. In some examples, higher temporal correlation classes may be assigned R1 and/or R2 values that increase allocation to an anchor frame or another prediction-important frame because that frame can influence multiple dependent frames. Lower temporal correlation classes may be assigned smaller, zero, or negative adjustment ratios because additional bits assigned to an anchor frame may provide less benefit when subsequent frames are less strongly predicted from the anchor frame. Actual values stored in look-up table 910 can be codec-dependent, GOP-structure-dependent, layer-dependent, bitrate-dependent, resolution-dependent, or product-tuned.

In some examples, determine temporary first and second frame bit allocations 904 in bit allocation adjustment 520 can apply adjustment ratio values R1 and R2 to initial bit allocation 518 to generate temporary adjusted bit allocations. For example, if Bᵢₙᵢₜ[i] denotes an initial bit allocation for frame i, bit allocation adjustment 520 can determine or calculate:

$${B}_{tmp} [ 1 ] = ( 1 + R 1 ) * {B}_{init} [ 1 ]$$

$${B}_{tmp} [ 2 ] = ( 1 + R 2 ) * {B}_{init} [ 2 ]$$

For frames other than the first and second frames, bit allocation adjustment 520 can maintain the corresponding initial bit allocations before normalization, e.g.:

$${B}_{t m p} [ i ] = {B}_{init} [ i ] for i > 2 .$$

This temporary adjustment changes relative emphasis among frames while preserving flexibility to normalize the final allocation.

In some examples, calculate sum of adjusted bit allocations 906 in bit allocation adjustment 520 can determine a sum of temporary adjusted bit allocations. For a group-of-pictures having M frames, bit allocation adjustment 520 can calculate or determine:

$$Sum\_adjust = {\sum }_{i = 1}^{M} {B}_{tmp} [ i ]$$

Equivalently, when only first and second frame allocations are adjusted before normalization, bit allocation adjustment 520 can determine or calculate:

$$Sum\_adjust = Sum\_initial + R 1 * {B}_{iinit} [ 1 ] + R 2 * {B}_{init} [ 2 ]$$

$$Sum\_initial = {\sum }_{i = 1}^{M} {B}_{init} [ i ]$$

Calculating Sum_adjust allows the adjustment to be converted into a normalized allocation that changes relative distribution without unintentionally changing or violating an overall bit budget.

In some examples, calculate normalized frame bit allocations 908 in bit allocation adjustment 520 can normalize the temporary adjusted bit allocations to generate bit allocation 530. For example, bit allocation adjustment 520 can determine or calculate:

$${B}_{final} [ i ] = {B}_{t m p} [ i ] * Sum\_initial / Sum\_adjust for each frame i of the group - of - pictures$$

This normalization can preserve the total bit budget for the group-of-pictures because

$${\sum }_{i = 1}^{M} {B}_{f i n a l} [ i ]$$

equals or approximately equals Sum_initial, while still reflecting class-based adjustment ratio values R1 and R2. In some examples, rounding, clipping, buffer checking, or redistribution of rounding residuals can be applied so that frame-level allocations satisfy integer bit constraints, buffer constraints, or encoder-specific constraints.

In some examples, bit allocation 530 can include normalized frame bit allocations for one or more frames of the group-of-pictures. Bit allocation 530 can be provided to encoder 102 to guide frame-level or layer-level rate-control targets during an encoding pass. Because bit allocation 530 is based on class 516 and initial bit allocation 518, bit allocation 530 can account for both relative coding complexity indicated by look-ahead frame sizes and temporal correlation indicated by statistic(s) 512. Using bit allocation 530 can improve allocation behavior relative to fixed GOP-position allocation by allowing rate control 296 to place bits where they are expected to provide greater coding or quality benefit.

In some examples, relative QP decision 522 can determine QP relationships among frames of the group-of-pictures. Look-up relative QP between first and second frames 922 in relative QP decision 522 can retrieve a recommended relative QP value from look-up table 930 based on class 516. In some examples, look-up table 930 can be indexed by, optionally, one or more additional parameters, such as GOP structure and/or size, miniGOP structure and/or size, hierarchical-layer structure and/or size, frame type, coding order, or another encoder configuration parameter. The recommended relative QP value can represent a QP relationship between a first frame and a second frame, between an anchor frame and one or more subsequent frames, or among multiple temporal layers of the group-of-pictures.

A relative QP value can indicate a QP relationship between frames or layers of a group-of-pictures, such as a difference between a QP assigned to a first frame or anchor frame and a QP assigned to a second frame or subsequent frame. In some examples, higher temporal correlation classes can correspond to larger relative QP magnitudes because the quality of an anchor frame or lower-layer reference frame may have a greater effect on subsequent dependent frames, while lower temporal correlation classes can correspond to smaller relative QP magnitudes because stronger QP separation may provide less coding benefit. Relative QP decision 522, e.g., look-up relative QP between first and second frames 922 can retrieve a recommended relative QP value from look-up table 930 and assign QP values to frames of the group-of-pictures using that recommended relative QP value, such as by assigning an anchor-frame QP and then assigning one or more subsequent-frame QPs relative to the anchor-frame QP. An example look-up table 930 is as follows:

| Temporal correlation class | Example relative QP value | Example |
|---|---|---|
| 516 | between 1st and 2nd frames | interpretation |
| Class 1 - low temporal | +1 | Small QP |
| correlation | | separation |
| Class 2 - low-medium | +2 | Mild QP |
| temporal correlation | | separation |
| Class 3 - medium temporal | +3 | Moderate QP |
| correlation | | separation |
| Class 4 - medium-high | +4 | Larger QP |
| temporal correlation | | separation |
| Class 5 - high temporal | +5 | Stronger QP |
| correlation | | separation |

Relative QP values stored in look-up table 930 can be determined through one or more mechanisms, such as empirically, analytically, or through encoder tuning based on how different QP relationships affect coding efficiency and quality propagation within a group-of-pictures. For example, training video clips can be encoded using multiple candidate relative QP values between an anchor frame and one or more subsequent frames or layers, and a recommended relative QP value can be selected for each temporal correlation class based on one or more objectives, such as reducing quality fluctuation, improving worst-frame quality, improving rate-distortion performance, improving bitrate accuracy, or maintaining buffer compliance. In some examples, higher temporal correlation classes may be assigned larger relative QP magnitudes because improving the quality of an anchor frame or lower-layer reference frame may provide greater benefit to dependent frames, while lower temporal correlation classes may be assigned smaller relative QP magnitudes because subsequent frames are less strongly predicted from the anchor frame. Relative QP values may be codec-dependent, GOP-structure-dependent, temporal-layer-dependent, bitrate-dependent, resolution-dependent, content-dependent, or product-tuned. Relative QP values may be generated offline, updated through calibration, or selected using rule-based design.

In some examples, assign QP values 924 in relative QP decision 522 can calculate respective QPs for one or more frames of the group-of-pictures using the recommended relative QP value. For example, if QP_anchor denotes a QP assigned to an anchor frame and RelQP[layer] denotes a relative QP value for a frame or layer, relative QP decision 522 can determine or calculate:

$$QP\_i = QP\_anchor + RelQP [ layer ( i ) ] for a frame i$$

In another example, relative QP decision 522 can assign a QP to a second frame based on a relative QP value between the first and second frames and can assign QPs to other frames according to a temporal-layer pattern or GOP-structure-specific template. Relative QP decision 540 can define a QP distribution across frames through generation of relative QP decision 540.

In some examples, determining bit allocation 530 and relative QP decision 540 using class 516 can provide coordinated control over both bit distribution and quantization relationships within a group-of-pictures. For example, class 516 can indicate whether the group-of-pictures has low, medium, or high temporal correlation, and look-up tables 910 and 930 can translate that class into frame-allocation and QP-relationship decisions suitable for that correlation level. This coordination can reduce quality fluctuation, avoid inefficient bit spending on frames that provide limited prediction benefit, and improve quality of frames or layers that influence dependent frames.

In some examples, bit allocation adjustment 520 and relative QP decision 522 can also provide baseline decisions that are later refined using actual-encoding feedback, such as when a further temporal correlation class or an actual encoding QP indicates that look-ahead-derived decisions should be updated.

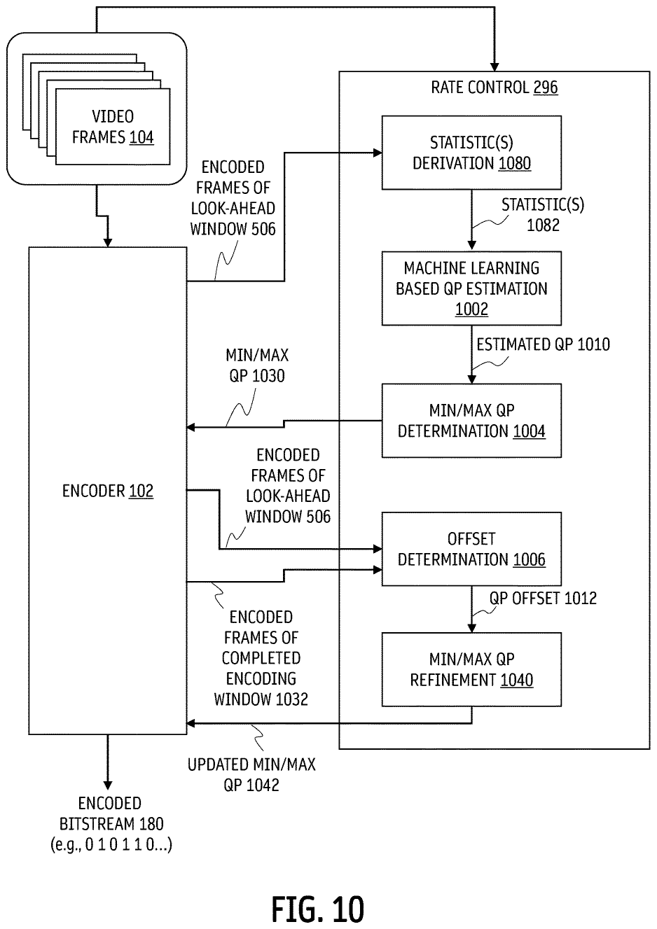

FIG. 10 illustrates a further rate control process, according to some examples of the disclosure. Rate control 296 can determine one or more of minimum QP and maximum QP for an encoding pass (e.g., min/max QP 1030 and updated min/max QP 1042). Minimum QP and maximum QP can be used to constrain actual encoding QP decisions made by encoder 102, such that encoder 102 can avoid QP values that are too low or too high for a current coding condition. Constraining the QP used in the actual encoding pass can reduce excessive QP movement, reduce unnecessary bit spending when quality is already sufficient, and reduce quality degradation caused by overly aggressive quantization.

In some examples, statistic(s) derivation 1080 can receive encoded frames of look-ahead window 506 and derive statistic(s) 1082. Statistic(s) 1082 can include one or more input features associated with encoded frames generated from a look-ahead encoding pass. For example, statistic(s) 1082 can include one or more of: average encoded bits, average syntax bits, average skip percentage, average intra percentage, average peak signal-to-noise ratio, average target frame size, or another statistic derived from look-ahead coding behavior. Statistic(s) 1082 can provide a compact representation of how difficult the frames are expected to be to encode and how the look-ahead pass behaved under a particular look-ahead QP.

In some examples, machine learning based QP estimation 1002 can receive statistic(s) 1082 and generate estimated QP 1010. Machine learning based QP estimation 1002 can apply a machine-learning model to one or more input features associated with encoded frames generated from the look-ahead encoding pass. In some examples, machine learning based QP estimation 1002 can estimate or infer an average encoding QP expected to be used during an actual encoding pass for a current look-ahead window, group-of-pictures, anchor frame, or encoding window. Estimated QP 1010 can therefore provide rate control 296 with a prediction of actual encoder QP behavior before or while the corresponding frames are encoded.

In some examples, min/max QP determination 1004 can determine min/max QP 1030 based on estimated QP 1010. In some examples, min/max QP determination 1004 can receive estimated QP 1010 and determine min/max QP 1030. In some examples, min/max QP determination 1004 can determine a minimum QP and maximum QP by applying a margin to or around estimated QP 1010. For example, if estimated QP 1010 is represented as QP_est, min/max QP determination 1004 can determine or calculate:

$$Min QP = QP\_est - C$$

$$Max QP = QP\_est + C$$

C is a margin value (e.g., C can be in a range of 1 to 5). In some examples, C can be a fixed value, a codec-dependent value, a content-dependent value, a bitrate-dependent value, or a value selected from a range such as 1 to 5. In some examples, min/max QP determination 1004 can also clip MinQP and MaxQP to a supported QP range for encoder 102. Min/max QP 1030 can be provided to encoder 102 and used to constrain QP selection during an encoding pass. Min/max QP 1030 can define an allowable QP range within which encoder 102 can select actual encoding QP values while trying to satisfy rate-control targets, buffer constraints, or quality objectives. Constraining the QP being used in the encoding pass can reduce undesirable behavior in which actual encoding QP is aggressively adjusted upward or downward to satisfy short-term rate-control pressure. For example, min/max QP 1030 can reduce a risk of excessive quality loss caused by an overly large QP and can reduce unnecessary bit spending caused by an overly small QP.

In some examples, offset determination 1006 can determine QP offset 1012 using encoded frames of look-ahead window 506 and encoded frames of completed encoding window 1032. In some examples, offset determination 1006 can receive information associated with encoded frames of look-ahead window 506 and encoded frames of completed encoding window 1032 and can determine QP offset 1012. Encoded frames of completed encoding window 1032 can represent frames that have already been encoded during an encoding pass, and encoded frames of look-ahead window 506 can represent corresponding look-ahead encoded frames or corresponding look-ahead-derived QP estimates.

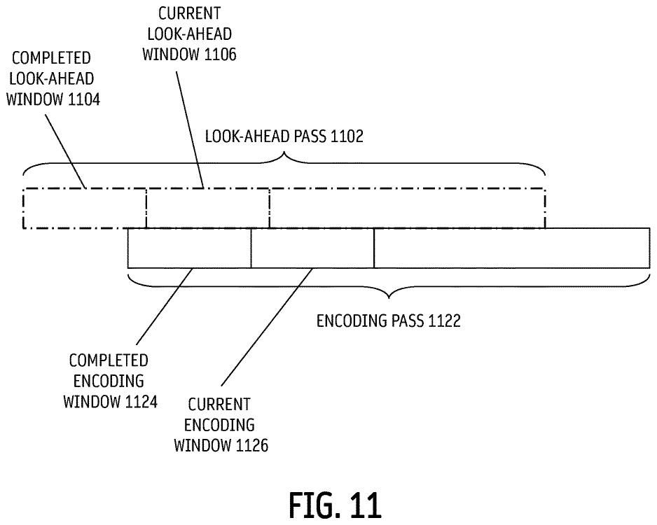

Referring briefly to FIG. 11, look-ahead pass 1102 can operate ahead of encoding pass 1122, such that completed look-ahead window 1104 corresponds to frames for which look-ahead-derived information is already available, and current look-ahead window 1106 corresponds to frames currently being analyzed or used for upcoming rate-control decisions. Similarly, completed encoding window 1124 can correspond to frames that have already been encoded during encoding pass 1122, and current encoding window 1126 can correspond to frames currently being encoded or scheduled for encoding.

In some examples, offset determination 1006 can compare QP information from completed encoding window 1124 with estimated QP information from corresponding completed look-ahead window 1104 to determine QP offset 1012, while current look-ahead window 1106 can provide estimated QP information used to determine or refine minimum QP and maximum QP for current encoding window 1126 or a subsequent encoding window.

Referring back to FIG. 10, in some examples, offset determination 1006 can compare QP behavior observed during the completed encoding window (e.g., completed encoding window 1124 or encoded frames of completed encoding window 1032) with QP behavior estimated from the corresponding look-ahead window (e.g., completed look-ahead window 1104 or encoded frames of look-ahead window 506). In some examples, QP offset 1012 can be based on a difference between an average or representative QP used in completed encoding window 1032 (or completed encoding window 1124) and an average or representative estimated QP for a corresponding completed look-ahead window (e.g., encoded frames of look-ahead window 506 or completed look-ahead window 1104).

Offset determination 1006 can determine QP offset 1012 based on a difference between average or representative QP used in completed encoding window 1032 and average or representative estimated QP for a corresponding completed look-ahead window. For example, offset determination 1006 can determine or calculate:

$$QP\_offset = ( QP\_encoding \_average - QP\_estimate \_average ) * W$$

QP_encoding_average represents an average or representative QP used in completed encoding window 1032 or completed encoding window 1124. QP_estimate_average represents an average or representative estimated QP for a corresponding completed look-ahead window (e.g., encoded frames of look-ahead window 506 or completed look-ahead window 1104). W represents a weighting factor.

In some examples, QP offset 1012 can represent a feedback correction for systematic mismatch between estimated QP behavior and actual encoding QP behavior. When QP_encoding_average is larger than QP_estimate_average, QP offset 1012 can be positive, indicating that actual encoding used a larger QP than predicted. When QP_encoding_average is smaller than QP_estimate_average, QP offset 1012 can be negative, indicating that actual encoding used a smaller QP than predicted. Weighting factor W can control how strongly completed-window feedback affects later QP range decisions and, in some examples, can be selected from a range such as 0 to 0.5 or another empirically tuned range.

In some examples, QP offset 1012 can be positive when actual encoding uses a larger QP than estimated, and QP offset 1012 can be negative when actual encoding uses a smaller QP than estimated. QP offset 1012 can represent a feedback correction that accounts for mismatch between look-ahead prediction and actual encoding behavior.

In some examples, min/max QP refinement 1040 can receive QP offset 1012 and refine minimum QP and maximum QP for subsequent encoding decisions. In some examples, min/max QP refinement 1040 can receive QP offset 1012 and refine min/max QP 1030 to generate updated min/max QP 1042. In some examples, min/max QP refinement 1040 can determine a base minimum QP and maximum QP from a current estimated QP and then shift the base range using QP offset 1012. In some examples, min/max QP refinement 1040 can first determine a current minimum QP and maximum QP based on a current estimated QP and can shift the current range using QP offset 1012. For example, min/max QP refinement 1040 can determine or calculate:

$$Updated Min QP = Min QP + QP\_offset$$

$$Updated Max QP = Max QP + QP\_offset$$

Updated min/max QP 1042 can be provided to encoder 102 for use during an encoding pass for subsequent frames, subsequent anchor frames, a subsequent group-of-pictures, or a subsequent encoding window.

In some examples, min/max QP refinement 1040 can optionally clip updated min/max QP 1042 to an encoder-supported QP range. Optionally, min/max QP refinement 1040 can enforce UpdatedMinQP≤UpdatedMaxQP. Optionally, min/max QP refinement 1040 can enforce smooth changes of QP offset 1012 across windows. Optionally, min/max QP refinement 1040 can limit a maximum amount of range shift of updated min/max QP 1042 between successive encoding windows.

In some examples, updated min/max QP 1042 can be provided to encoder 102 for subsequent frames, subsequent anchor frames, a current encoding window, a subsequent encoding window, or a suitable rate-control unit. Updated min/max QP 1042 can allow rate control 296 to adapt QP range constraints based on actual-encoding feedback without discarding information from look-ahead-derived estimated QP 1010. Min/max QP 1030 and updated min/max QP 1042 can be used independently of class-based bit allocation or relative QP value determination or can be used with those operations so that bit allocation targets, relative QP relationships, and allowable QP ranges are coordinated.

In some examples, determining and optionally refining minimum QP and maximum QP can provide several technical advantages. Machine learning-based QP estimation 1002 can use statistic(s) 1082 to predict an encoding QP that reflects look-ahead coding behavior, target frame size, and content characteristics. Min/max QP determination 1004 can convert that prediction into a practical QP range for encoder 102, thereby reducing extreme QP decisions. Offset determination 1006 and min/max QP refinement 1040 can adapt the QP range using actual encoding feedback, thereby correcting mismatch between look-ahead predictions and actual encoding behavior. Determining and optionally refining minimum QP and maximum QP can improve rate-control stability, reduce quality fluctuation, improve worst-frame quality, reduce unnecessary bit waste, and provide a modular QP range-control mechanism that can be combined with or implemented separately from other rate-control operations.

In some examples, min/max QP 1030 and updated min/max QP 1042 can be used independently of, or together with, bit allocation and relative QP value decisions described herein. For example, encoder 102 can use min/max QP 1030 to constrain QP values even when temporal-correlation-class-based bit allocation or relative QP value determination is omitted, simplified, or disabled. In another example, encoder 102 can use min/max QP 1030 or updated min/max QP 1042 together with bit allocation and relative QP values so that frame-level bit targets, inter-frame QP relationships, and allowable QP ranges are coordinated.

In some examples, rate control 296 can provide technical advantages by using estimated QP 1010, min/max QP 1030, and/or QP offset 1012 to control QP range decisions. Estimated QP 1010 and min/max QP 1030 allow min/max QP determination 1004 to establish a QP range that is tailored to look-ahead statistics rather than relying only on a fixed or generic range. QP offset 1012 allows min/max QP refinement 1040 to account for actual encoding feedback, so that updated min/max QP 1042 can track systematic differences between predicted and actual encoding behavior. Utilizing estimated QP 1010, min/max QP 1030, and/or QP offset 1012 can improve rate-control stability, reduce the risk of extreme QP decisions, improve worst-frame quality, and reduce unnecessary bit waste.

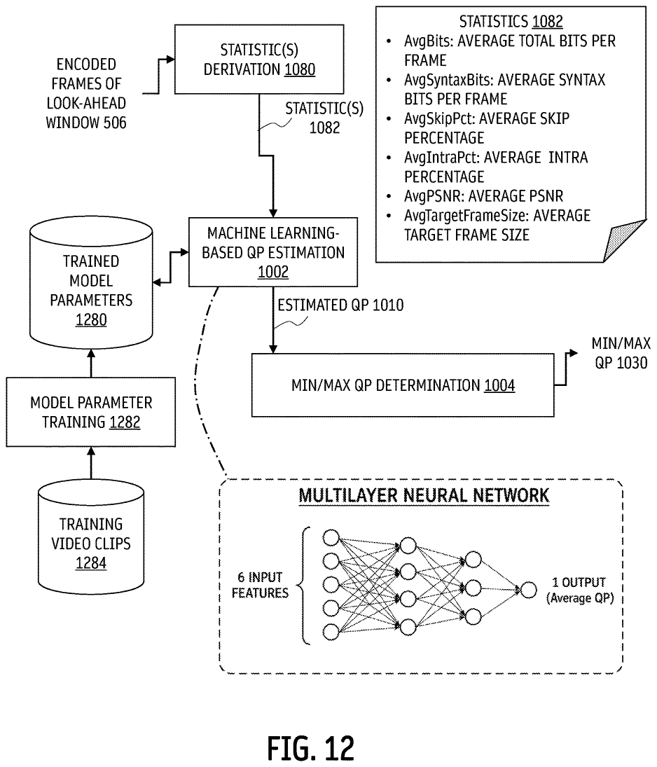

FIG. 12 illustrates determining and optionally refining a maximum quantization parameter and a minimum quantization parameter, according to some examples of the disclosure. Statistic(s) derivation 1080 can receive encoded frames of look-ahead window 506 and derive statistic(s) 1082. Statistic(s) 1082 can include one or more input features associated with the plurality of encoded frames generated from a look-ahead encoding pass. For example, statistic(s) 1082 can include one or more of: AvgBits (representing average total bits per frame), AvgSyntaxBits (representing average syntax bits per frame), AvgSkipPct (representing average skip percentage), AvgIntraPct (representing average intra percentage), AvgPSNR (representing average peak signal-to-noise ratio (PSNR)), and AvgTargetFrameSize (representing average target frame size).

In some examples, statistic(s) derivation 1080 can generate statistic(s) 1082 by parsing or analyzing encoded frames of look-ahead window 506. For a look-ahead window having N frames, statistic(s) derivation 1080 can calculate or determine:

$$AvgBits = \frac{1}{N} \sum Bits [ i ]$$

Bits[i] represents encoded bits for frame i

In some examples, statistic(s) derivation 1080 can calculate or determine:

$$AvgSyntaxBits = \frac{1}{N} \sum SyntaxBits [ i ]$$

SyntaxBits[i] represents bits associated with syntax elements for frame i.

In some examples, statistic(s) derivation 1080 can calculate or determine:

$$AvgSkipPct = \frac{1}{N} \sum SkipPct [ i ]$$

SkipPct[i] represents a skip-coded proportion or percentage of frame i.

In some examples, statistic(s) derivation 1080 can calculate or determine:

$$AvgIntraPct = \frac{1}{N} \sum IntraPct [ i ]$$

IntraPct[i] represents an intra-coded portion of frame i.

In some examples, distortion or quality information is available from the look-ahead encoding pass. Statistic(s) derivation 1080 can determine or calculate:

$$AvgPSNR = \frac{1}{N} \sum PSNR [ i ]$$

PSNR[i] represents the PSNR of frame i.

Statistic(s) 1082 can represent coding cost and/or prediction behavior observed during the look-ahead encoding pass.

In some examples, machine learning-based QP estimation 1002 can receive statistic(s) 1082 and trained model parameters 1280 and can generate estimated QP 1010. Machine learning-based QP estimation 1002 can apply a machine-learning model to one or more input features associated with encoded frames of look-ahead window 506 (e.g., including one or more features of statistic(s) 1082).

In some examples, machine learning-based QP estimation 1002 can apply a multilayer neural network having one or more input features comprising one or more of: AvgBits, AvgSyntaxBits, AvgSkipPct, AvgIntraPct, AvgPSNR, and AvgTargetFrameSize, and one output corresponding to an estimated average QP. In other examples, more or fewer input features, different input features, or a different machine-learning model may be used.

Machine learning-based QP estimation 1002 is illustrated with a multilayer neural network as one example, but other machine-learning models may be used to generate estimated QP 1010 from statistic(s) 1082. For example, machine learning-based QP estimation 1002 may use one or more of: a linear regression model, ridge regression model, support vector regression model, decision tree, random forest, gradient-boosted tree model, adaptive boosting model, k-nearest-neighbor regression model, Bayesian regression model, Gaussian process regression model, shallow neural network, convolutional neural network, recurrent neural network, transformer-based model, or a suitable supervised learning model. In some examples, machine learning-based QP estimation 1002 may use an ensemble of models or a hybrid model that combines rule-based estimation with learned correction. The selected model may depend on encoder complexity, available training data, desired inference cost, implementation platform, and prediction accuracy requirements, so long as the model maps one or more input features associated with encoded frames of look-ahead window 506 to estimated QP 1010.

In some examples, trained model parameters 1280 can include one or more of weights, biases, coefficients, decision-tree parameters, normalization parameters, scaling parameters, feature transformation parameters, and suitable model parameters used by machine learning-based QP estimation 1002. Model parameter training 1282 can generate trained model parameters 1280 based on training video clips 1284. For example, training video clips 1284 can be encoded during an offline training stage under one or more of different target bit rates, resolutions, compression ratios, QP values, GOP structures, encoder configurations, and content types to produce training samples. A training sample can include an input feature vector derived from encoded training frames and target-rate information, and an output label corresponding to an actual average encoding QP observed during the training encode. Model parameter training 1282 can train a model to map encoded-frame statistics and target frame-size information to an estimated encoding QP.

In some examples, training video clips 1284 can include content having one or more of different motion levels, scene-change behavior, noise characteristics, texture complexity, spatial resolutions, frame rates, and bitrate targets. The input feature vector for a training sample can include, for example, one or more of average total encoded bits, average syntax bits, average skip percentage, average intra percentage, average Peak Signal-to-Noise Ratio, and average target frame size. The output label can correspond to an actual average encoding QP used to encode the same or corresponding training frames. Model parameter training 1282 can select trained model parameters 1280 by reducing a difference between predicted QP values and actual average encoding QP values, such as by minimizing a squared error, absolute error, weighted error, or a suitable training objective. Training across varied content can improve the ability of machine learning-based QP estimation 1002 to predict QP behavior for different video content and rate-control conditions.

Once generated, trained model parameters 1280 can be stored and later used by machine learning-based QP estimation 1002 during operation of encoder 102. During runtime, statistic(s) 1082 may be derived from encoded frames of look-ahead window 506 and supplied to machine learning-based QP estimation 1002 as input features. Machine learning-based QP estimation 1002 can then apply trained model parameters 1280 to statistic(s) 1082 to generate estimated QP 1010. Model parameter training 1282 can be performed offline using training video clips 1284, while machine learning-based QP estimation 1002 can use the resulting trained model parameters 1280 online to estimate QP from look-ahead-derived statistic(s) 1082.

In some examples, estimated QP 1010 can represent an estimated encoding QP for encoded frames of look-ahead window 506, a group-of-pictures, an anchor frame, a current encoding window, or a suitable rate-control unit. Estimated QP 1010 can be an estimated average QP expected to be used during an encoding pass. Because estimated QP 1010 is generated from statistic(s) 1082 that reflect coding behavior of encoded frames of look-ahead window 506, greater accuracy of estimated QP 1010 can allow min/max QP determination 1004 to set a more appropriate QP range for the encoding pass. For example, when estimated QP 1010 more closely predicts the QP values expected during actual encoding, minimum QP and maximum QP can be centered around a more accurate operating point, thereby reducing the likelihood that the QP range is too restrictive, too permissive, or shifted away from the QP values that encoder 102 is likely to use.

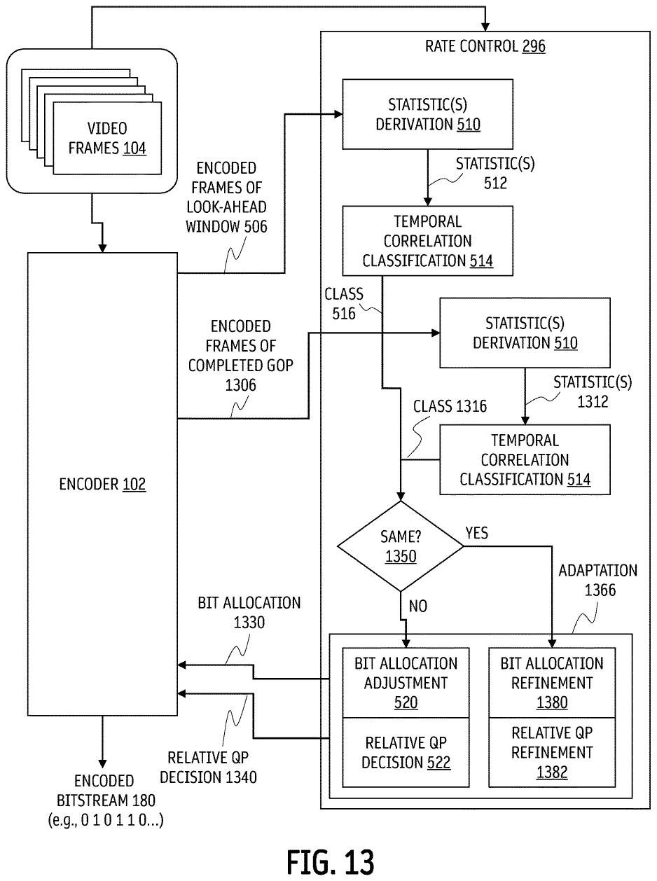

FIG. 13 illustrates a yet further rate control process, according to some examples of the disclosure. In particular, FIG. 13 illustrates how rate control 296 can use an initially determined temporal correlation class and a further temporal correlation class derived from encoded frames of completed GOP 1306 to update or refine one or more rate-control decisions after encoding has begun or when actual encoding feedback information is available. In this context, “completed miniGOP” can refer to a miniGOP, GOP, hierarchical GOP, portion of a larger GOP, or other group of frames for which encoded-frame information is available from an encoding pass.

In some examples, statistic(s) derivation 510 can derive statistic(s) 512 from encoded frames of look-ahead window 506, and temporal correlation classification 514 can determine class 516 based on statistic(s) 512. Class 516 can represent an initial temporal correlation class determined from look-ahead-derived statistics. Class 516 can be used to determine one or more initial rate-control decisions for a group-of-pictures, such as bit allocation and relative QP value.

In some examples, statistic(s) derivation 510 can also receive encoded frames of completed GOP 1306. Encoded frames of completed GOP 1306 can include one or more further encoded frames generated during an encoding pass after a miniGOP has been encoded. For example, encoded frames of completed GOP 1306 may include encoded frames of a first completed miniGOP in a video sequence whose actual encoding statistics are used to refine bit allocation 1330 and relative QP decision 1340 for a subsequent miniGOP, a subsequent encoding window, or another subsequent rate-control unit of the video sequence. Statistic(s) derivation 510 can extract one or more further statistics 1312 from encoded frames of completed GOP 1306, such as one or more of: frame-size related statistics, intra-coded block statistics, skip-coded block statistics, QP-related statistics, and suitable coding-behavior statistics. In some examples, statistic(s) derivation 510 derives or updates a subset of statistic(s) 512 to form statistic(s) 1312.

In some examples, statistic(s) derivation 510 can calculate a weighted average of intra-percentage values and a weighted average of skip-percentage values based on one or more further encoded frames generated during an encoding pass (e.g., encoded frames of completed GOP 1306). For example, the weighted averages may combine intra-percentage and skip-percentage values derived from encoded frames of completed GOP 1306, from an anchor frame and one or more subsequent frames, or from a combination of actual-encoding statistics and corresponding look-ahead statistics. Temporal correlation classification 514 can use the weighted average intra percentage and weighted average skip percentage as statistic(s) 1312 to determine class 1316 as a further temporal correlation class. This allows class 1316 to reflect actual encoded-frame behavior while reducing sensitivity to a single frame or noisy statistic.

In some examples, temporal correlation classification 514 can determine class 1316 based on the further statistics (e.g., one or more further statistics 1312) derived from encoded frames of completed GOP 1306. Class 1316 can represent a further temporal correlation class determined using actual encoded-frame behavior rather than only look-ahead-derived behavior. Because actual encoding may produce statistics that differ from look-ahead statistics, class 1316 can provide a feedback-based indication of whether the temporal correlation assessment used for earlier rate-control decisions should be maintained or updated.

Decision 1350 (“Same?”) can compare class 516 and class 1316. Class 516 can represent the temporal correlation class determined from encoded frames of look-ahead window 506, while class 1316 can represent the further temporal correlation class determined from encoded frames of completed GOP 1306. Decision 1350 can determine whether class 516 and class 1316 are the same or different. In some examples, decision 1350 can perform an exact equality comparison. In other examples, decision 1350 can use one or more of tolerance, hysteresis, class-distance thresholds, confidence values, or another comparison rule for determining whether class 516 and class 1316 should be treated as matching for refinement purposes.

In some examples, decision 1350 determines that class 516 and class 1316 are different. Rate control 296 can use bit allocation adjustment 520 and/or relative QP decision 522 in adaptation 1366 to update one or more of bit allocation 1330 and relative QP decision 1340 based on class 1316. In this case, class 1316 can indicate that the initially determined class 516 did not sufficiently match actual encoded-frame behavior for encoded frames of completed GOP 1306. Updating bit allocation 1330 and relative QP decision 1340 based on class 1316 allows rate control 296 to reselect class-dependent adjustment ratios and relative QP values rather than merely scaling or preserving a class-dependent decision associated with class 516.

In some examples, decision 1350 determines that class 516 and class 1316 are the same. Rate control 296 can use bit allocation refinement 1380 and/or relative QP refinement 1382 in adaptation 1366 to perform a feedback-based refinement while preserving the temporal correlation class. Adaptation 1366 can use a comparison between actual encoding QP of one or more frames of completed GOP 1306 and a look-ahead QP to determine whether and how to change bit allocation and/or relative QP value. For example, adaptation 1366 can indicate whether a bit allocation ratio between layers of a group-of-pictures should be increased, decreased, or maintained, and whether a magnitude of a relative QP value between layers should be increased, decreased, or maintained.

In some examples, bit allocation refinement 1380 can refine bit allocation 1330 based on adaptation 1366. In some examples, bit allocation refinement 1380 can increase a bit allocation ratio between layers of a group-of-pictures when the actual encoding QP is larger than the look-ahead QP, decrease the bit allocation ratio when the actual encoding QP is smaller than the look-ahead QP, or maintain the bit allocation ratio when the actual encoding QP is the same as the look-ahead QP.

In some examples, relative QP refinement 1382 can refine relative QP decision 1340 based on adaptation 1366. In some examples, relative QP refinement 1382 can increase a magnitude of a relative QP value between layers when the actual encoding QP is larger than the look-ahead QP, decrease the magnitude when the actual encoding QP is smaller than the look-ahead QP, or maintain the magnitude when the actual encoding QP is the same as the look-ahead QP.

In some examples, bit allocation 1330 and relative QP decision 1340 can be provided to encoder 102 for use in encoding one or more frames. Bit allocation 1330 can include frame-level or layer-level bit allocation values determined by bit allocation adjustment 520 or bit allocation refinement 1380. Relative QP decision 1340 can include one or more relative QP values, QP relationships, or frame-specific QP assignments determined by relative QP decision 522 or relative QP refinement 1382. In some examples, bit allocation 1330 and relative QP decision 1340 can be applied to a subsequent miniGOP, a subsequent group-of-pictures, a subsequent encoding window, a re-encoded group of frames, or a suitable subsequent rate-control unit.

In some examples, the feedback-based rate control process of FIG. 13 can provide technical advantages by allowing rate control 296 to respond to differences between look-ahead-derived statistics and actual encoded-frame behavior. When class 1316 differs from class 516, rate control 296 can update class-dependent bit allocation and relative QP value decisions using class 1316. When class 1316 matches class 516, rate control 296 can preserve the temporal correlation class while fine-tuning bit allocation ratios and relative QP magnitudes based on actual encoding QP behavior. This can reduce quality fluctuation, improve robustness for changing or difficult content, and reduce reliance on a single look-ahead-derived classification.

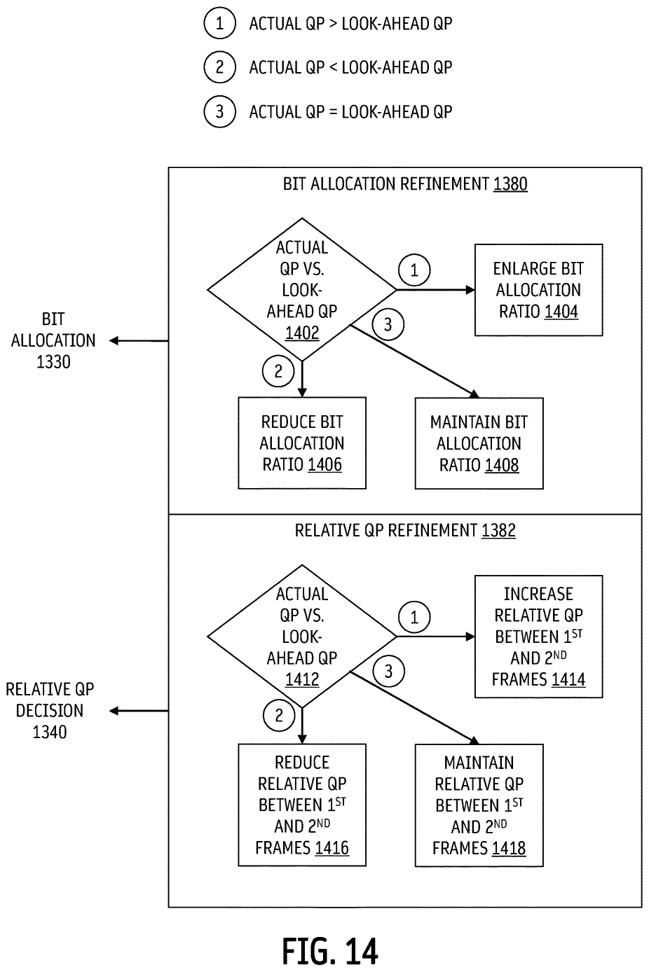

FIG. 14 illustrates refining the bit allocation and the relative quantization parameter value, according to some examples of the disclosure. In particular, FIG. 14 illustrates a same-class refinement path, such as when class 516 and class 1316 of FIG. 13 are determined to be the same. In that case, rate control 296 may preserve the temporal correlation class and refine one or more of bit allocation 1330 and relative QP decision 1340 based on a comparison between the actual encoding QP and the look-ahead QP.

In some examples, bit allocation refinement 1380 can compare the actual QP and the look-ahead QP at decision 1402. The actual QP can represent a (representative) QP used by encoder 102 when encoding one or more frames, such as encoded frames of completed GOP 1306, encoded frames of a completed GOP, encoded frames of a completed encoding window, or encoded frames of a set of further encoded frames. The look-ahead QP can represent a (representative) QP used during a look-ahead encoding pass or a QP associated with look-ahead-derived analysis. Decision 1402 can determine whether the actual QP is greater than, less than, or equal to the look-ahead QP, as represented by cases 1, 2, and 3.

When the actual QP is greater than the look-ahead QP (case 1), bit allocation refinement 1380 can enlarge bit allocation ratio 1404. A larger actual QP can indicate that the encoding pass used coarser quantization than the look-ahead pass or than expected from the look-ahead pass. In response, rate control 296 can increase a bit allocation ratio between layers of the group-of-pictures, such as by increasing relative emphasis on an anchor frame, reference frame, lower temporal layer, or other prediction-important frame. For example, a base allocation ratio between an anchor layer and one or more subsequent layers may be increased so that more bits are allocated to frames expected to influence dependent frames.

When the actual QP is less than the look-ahead QP (case 2), bit allocation refinement 1380 can reduce bit allocation ratio 1406. A smaller actual QP can indicate that the encoding pass used finer quantization than the look-ahead pass or that the actual encoding process spent more bits than expected. In response, rate control 296 can decrease a bit allocation ratio between layers of the group-of-pictures, such as by reducing the degree of anchor-frame or lower-layer emphasis and producing a flatter allocation among layers or frames. For example, if a prior allocation placed a large percentage of bits on an anchor frame, bit allocation refinement 1380 may reduce that percentage and redistribute bits more evenly among subsequent frames or layers.

When the actual QP is equal to the look-ahead QP (case 3), bit allocation refinement 1380 can maintain bit allocation ratio 1408. Equality between the actual QP and the look-ahead QP can indicate that look-ahead-derived behavior and actual encoding behavior are sufficiently aligned for the same-class refinement path. In response, rate control 296 can maintain a current bit allocation ratio between layers of the group-of-pictures, while optionally allowing other rate-control constraints, rounding rules, or buffer checks to be applied.

In some examples, enlarging, reducing, or maintaining the bit allocation ratio can be implemented using a scale factor, additive adjustment, table update, or other refinement value. For example, rate control 296 can calculate or determine:

$$QPdiff = ActualQP - LookAheadAP$$

When QPdiff>0 (case 1), enlarge bit allocation ratio 1404 can increase one or more layer ratios by a scale proportional to QPdiff. When QPdiff<0 (case 2), reduce bit allocation ratio 1406 can decrease one or more layer ratios by a scale proportional to QPdiff. When QPdiff=0 (case 3), maintain bit allocation ratio 1408 can leave the one or more layer ratios unchanged. In some examples, refined allocations can be normalized so that the total bit budget for a group-of-pictures, miniGOP, or encoding window is preserved.

In some examples, relative QP refinement 1382 can compare actual QP and look-ahead QP at decision 1412. Decision 1412 can use the same comparison as decision 1402 or a separate comparison based on one or more actual QP values, average or representative actual QP values, look-ahead QP values, estimated QP values, or filtered QP values. Relative QP refinement 1382 can use the comparison to determine whether to change a magnitude of a relative QP value between layers of a group-of-pictures, such as between a first frame and a second frame, between an anchor frame and a subsequent frame, or between a lower temporal layer and a higher temporal layer.

When actual QP is greater than look-ahead QP (case 1), relative QP refinement 1382 can increase relative QP between first and second frames 1414. Increasing relative QP can increase a magnitude of QP separation between frames or layers, such as by preserving or lowering relative QP for an anchor frame while increasing QP for a subsequent frame or higher temporal layer. For example, if a first frame has QP1 and a second frame is assigned using QP2=QP1+RelQP, increasing relative QP can increase RelQP so that the second frame is encoded at a larger QP relative to the first frame. This can help place relatively greater coding quality or bit emphasis on a prediction-important frame when actual encoding indicates a coarser operating point.

When actual QP is less than look-ahead QP (case 2), relative QP refinement 1382 can reduce relative QP between first and second frames 1416. Reducing relative QP can decrease a magnitude of QP separation between frames or layers, such as by moving QP values of subsequent frames closer to QP of an anchor frame. For example, if RelQP is initially +4, relative QP refinement 1382 may reduce RelQP to +3, +2, or another smaller value. This can reduce excessive separation between frames when actual encoding indicates that finer quantization or more bit spending occurred than expected.

When actual QP is equal to look-ahead QP (case 3), relative QP refinement 1382 can maintain relative QP between first and second frames 1418. Maintaining relative QP can preserve the current relative QP value, QP template, temporal-layer QP relationship, or first-frame-to-second-frame QP relationship. For example, if a first frame and second frame were assigned a relative QP value based on temporal correlation class, relative QP refinement 1382 can keep that relationship unchanged when actual encoding QP and look-ahead QP are aligned.

In some examples, bit allocation 1330 can include a refined bit allocation output by bit allocation refinement 1380. In some examples, relative QP decision 1340 can include a refined relative QP value or refined QP relationship output by relative QP refinement 1382. In some examples, bit allocation 1330 and/or relative QP decision 1340 can be applied to a subsequent miniGOP, subsequent GOP, subsequent encoding window, re-encoded group of frames, or a suitable subsequent or later rate-control unit. The refinement operations of FIG. 14 can provide a controlled feedback mechanism because they adjust the strength of bit-allocation and/or relative-QP relationships when the temporal correlation class remains valid, rather than reselecting a new temporal correlation class. This can reduce oscillation, improve stability, and adapt rate control 296 to mismatch between look-ahead behavior and actual encoding behavior.

### Example Methods for Encoding a Video

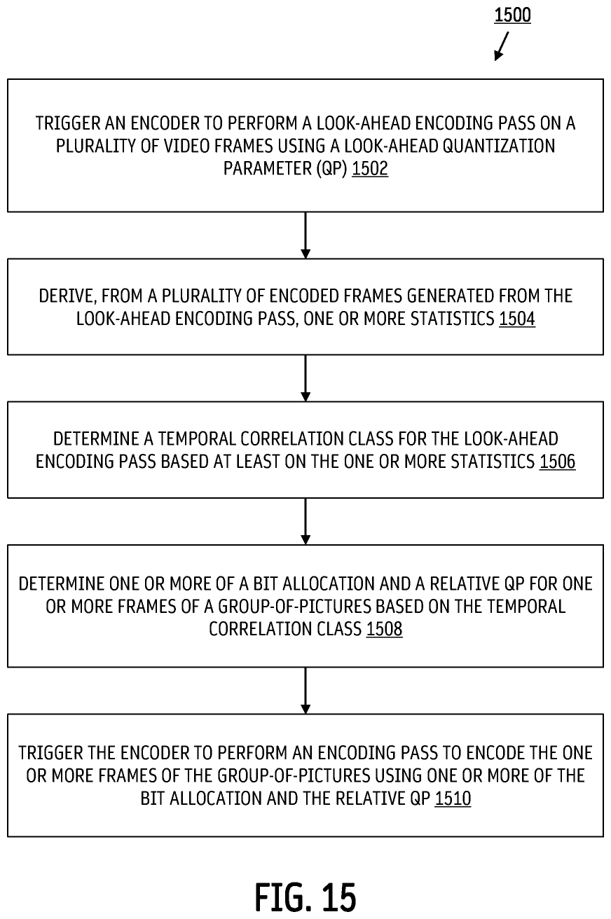

FIG. 15 illustrates method 1500 for encoding a video, according to some examples of the disclosure. Method 1500 can be performed by one or more instances of encoder 102 and/or one or more components of rate control 296.

In 1502, an encoder is triggered to perform a look-ahead encoding pass on a plurality of video frames using a look-ahead QP.

In 1504, one or more statistics are derived from a plurality of encoded frames generated from the look-ahead encoding pass.

In 1506, a temporal correlation class is determined for a group-of-pictures in the look-ahead encoding pass based on the one or more statistics.

In 1508, one or more of a bit allocation and a relative QP value are determined for one or more frames of the group-of-pictures based on the temporal correlation class.

In 1510, the encoder is triggered to perform an encoding pass to encode the one or more frames of the group-of-pictures using one or more of the bit allocation and the relative QP value.

### Example Computing Device

FIG. 16 is a block diagram of an apparatus or a system, e.g., an example computing device 1600, according to some examples of the disclosure. One or more computing devices 1600 may be used to implement the functionalities described with the FIGS. and herein. A number of components are illustrated in FIG. 16 that can be included in computing device 1600, but any one or more of these components may be omitted or duplicated, as suitable for the application. In some examples, some or all of the components included in computing device 1600 may be attached to one or more motherboards. In some examples, some or all of these components are fabricated onto a single system on a chip (SoC) die. Additionally, in various examples, computing device 1600 may not include one or more of the components illustrated in FIG. 16, and computing device 1600 may include interface circuitry for coupling to the one or more components. For example, computing device 1600 may not include a display device 1606, and may include display device interface circuitry (e.g., a connector and driver circuitry) to which a display device 1606 may be coupled. In another set of examples, computing device 1600 may not include audio input device 1618 or audio output device 1608 and may include audio input or output device interface circuitry (e.g., connectors and supporting circuitry) to which an audio input device 1618 or audio output device 1608 may be coupled.

Computing device 1600 may include a processing device 1602 (e.g., one or more processing devices, one or more of the same type of processing device, one or more of different types of processing devices). Processing device 1602 may include processing circuitry or electronic circuitry that processes electronic data from data storage elements (e.g., registers, memory, resistors, capacitors, quantum bit cells) to transform that electronic data into other electronic data that may be stored in registers and/or memory. Examples of processing device 1602 may include a CPU, a GPU, a quantum processor, a machine learning processor, an artificial intelligence processor, a neural-network processor, an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

Computing device 1600 may include a memory 1604, which may itself include one or more memory devices such as volatile memory (e.g., DRAM), nonvolatile memory (e.g., read-only memory (ROM)), high-bandwidth memory (HBM), flash memory, solid-state memory, and/or a hard drive. Memory 1604 includes one or more non-transitory computer-readable storage media. In some examples, memory 1604 may include memory that shares a die with the processing device 1602.

In some examples, memory 1604 includes one or more non-transitory computer-readable media storing instructions executable to perform operations described herein, such as operations illustrated in FIGS. 1-14, and method 1500 of FIG. 15. In some examples, memory 1604 includes one or more non-transitory computer-readable media storing instructions executable to perform one or more operations of encoder 102. In some examples, memory 1604 includes one or more non-transitory computer-readable media storing instructions executable to perform one or more operations of rate control 296. The instructions stored in memory 1604 may be executed by processing device 1602.

In some examples, memory 1604 may store data, e.g., data structures, binary data, bits, metadata, files, blobs, etc., as described with the FIGS. and herein. Memory 1604 may include one or more non-transitory computer-readable media storing one or more of: input frames to the encoder (e.g., video frames 104), intermediate data structures computed by the encoder, bitstream generated by the encoder (encoded bitstream 180), bitstream received by a decoder (encoded bitstream 180), intermediate data structures computed by the decoder, and reconstructed frames generated by the decoder. Memory 1604 may include decoded picture buffer 232. Memory 1604 may include one or more non-transitory computer-readable media storing one or more of: data received and/or data generated by operations illustrated in FIGS. 1-15. Memory 1604 may include one or more of training video clips 620, look-up table 616, look-up table 910, look-up table 930, trained model parameters 1280, and training video clips 1284.

In some examples, computing device 1600 may include a communication device 1612 (e.g., one or more communication devices). For example, communication device 1612 may be configured for managing wired and/or wireless communications for the transfer of data to and from computing device 1600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. Communication device 1612 may implement any of a number of wireless standards or protocols. Communication device 1612 may operate in accordance with other wireless protocols in other examples. Computing device 1600 may include an antenna 1622 to facilitate wireless communications and/or to receive other wireless communications (such as radio frequency transmissions). Computing device 1600 may include receiver circuits and/or transmitter circuits. In some examples, communication device 1612 may manage wired communications, such as electrical, optical, or any other suitable communication protocols (e.g., Ethernet). As noted above, communication device 1612 may include multiple communication chips. For instance, a first communication device 1612 may be dedicated to shorter-range wireless communications such as Wi-Fi or Bluetooth, and a second communication device 1612 may be dedicated to longer-range wireless communications. In some examples, a first communication device 1612 may be dedicated to wireless communications, and a second communication device 1612 may be dedicated to wired communications.

Computing device 1600 may include power source/power circuitry 1614. Power source/power circuitry 1614 may include one or more energy storage devices (e.g., batteries or capacitors) and/or circuitry for coupling components of computing device 1600 to an energy source separate from computing device 1600 (e.g., DC power, AC power, etc.).

Computing device 1600 may include display device 1606 (or corresponding interface circuitry, as discussed above). Display device 1606 may include any visual indicators, such as a heads-up display, a computer monitor, a projector, a touchscreen display, a liquid crystal display (LCD), a light-emitting diode display, or a flat panel display, for example.

Computing device 1600 may include audio output device 1608 (or corresponding interface circuitry, as discussed above). Audio output device 1608 may include any device that generates an audible indicator, such as speakers, headsets, or earbuds, for example.

Computing device 1600 may include audio input device 1618 (or corresponding interface circuitry, as discussed above). Audio input device 1618 may include any device that generates a signal representative of a sound, such as microphones, microphone arrays, or digital instruments (e.g., instruments having a musical instrument digital interface (MIDI) output).

Computing device 1600 may include global positioning system (GPS) device 1616 (or corresponding interface circuitry, as discussed above). GPS device 1616 may be in communication with a satellite-based system and may receive a location of computing device 1600, as known in the art.

Computing device 1600 may include sensor 1630 (or one or more sensors). Computing device 1600 may include corresponding interface circuitry, as discussed above). Sensor 1630 may sense physical phenomena and translate the physical phenomena into electrical signals that can be processed by, e.g., processing device 1602. Examples of sensor 1630 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1600 may include another output device 1610 (or corresponding interface circuitry, as discussed above). Examples of the other output device 1610 may include an audio codec, a video codec, a printer, a wired or wireless transmitter for providing information to other devices, haptic output device, gas output device, vibrational output device, lighting output device, home automation controller, or an additional storage device.

Computing device 1600 may include another input device 1620 (or corresponding interface circuitry, as discussed above). Examples of the other input device 1620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1600 may have any desired form factor, such as a handheld or mobile computer system (e.g., a cell phone, a smartphone, a mobile Internet device, a music player, a tablet computer, a laptop computer, a netbook computer, a personal digital assistant (PDA), an ultramobile personal computer, a remote control, a wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some examples, computing device 1600 may be any other electronic device that processes data.

### SELECT EXAMPLES

Example 1 provides one or more non-transitory computer-readable media storing instructions that, when executed by one or more processors, cause the one or more processors to perform operations including: triggering an encoder to perform a look-ahead encoding pass on a plurality of video frames using a look-ahead quantization parameter (QP); deriving, from a plurality of encoded frames generated from the look-ahead encoding pass, one or more statistics; determining a temporal correlation class for a group-of-pictures in the look-ahead encoding pass based on the one or more statistics; determining one or more of a bit allocation and a relative QP value for one or more frames of the group-of-pictures based on the temporal correlation class; and triggering the encoder to perform an encoding pass to encode the one or more frames of the group-of-pictures using one or more of the bit allocation and the relative QP value.

Example 2 provides the one or more non-transitory computer-readable media of example 1, where the operations further include determining the look-ahead QP based on one or more of a compression ratio and a resolution associated with the plurality of video frames.

Example 3 provides the one or more non-transitory computer-readable media of example 2, where determining the look-ahead QP includes indexing a look-up table using one or more of a compression ratio index and a resolution index.

Example 4 provides the one or more non-transitory computer-readable media of any one of examples 1-3, where the one or more statistics include one or more of: a frame-size related statistic, an intra-coded block statistic, and a skip-coded block statistic.

Example 5 provides the one or more non-transitory computer-readable media of any one of examples 1-4, where determining the temporal correlation class includes assigning the temporal correlation class based on a frame size of an anchor frame of the group-of-pictures, and one or more of an average frame size of the group-of-pictures and a maximum frame size of the group-of-pictures.

Example 6 provides the one or more non-transitory computer-readable media of any one of examples 1-5, where determining the temporal correlation class includes assigning the temporal correlation class based on an intra percentage, a skip percentage, and one or more threshold pairs associated with one or more candidate temporal correlation classes.

Example 7 provides the one or more non-transitory computer-readable media of any one of examples 1-6, where determining the bit allocation includes retrieving, from a table indexed by the temporal correlation class, one or more adjustment ratios for the one or more frames of the group-of-pictures; and calculating adjusted bit allocations using the one or more adjustment ratios.

Example 8 provides the one or more non-transitory computer-readable media of any one of examples 1-7, where determining the relative QP value includes retrieving, from a table indexed by the temporal correlation class, a recommended relative QP value for the one or more frames of the group-of-pictures; and calculating respective QPs for the one or more frames of the group-of-pictures using the recommended relative QP value.

Example 9 provides the one or more non-transitory computer-readable media of any one of examples 1-8, where the operations further include determining one or more of a minimum QP and a maximum QP for the encoding pass based on an estimated encoding QP.

Example 10 provides the one or more non-transitory computer-readable media of example 9, where the estimated encoding QP is generated by applying a machine-learning model on one or more input features associated with the plurality of encoded frames generated from the look-ahead encoding pass; and the one or more input features include one or more of: average encoded bits, average syntax bits, average skip percentage, average intra percentage, average peak signal-to-noise ratio, or average target frame size.

Example 11 provides the one or more non-transitory computer-readable media of any one of examples 1-10, where the operations further include determining a minimum QP and a maximum QP based on an offset to an estimated encoding QP, where the offset is based on a difference between an average QP used in a completed encoding window and an average estimated QP for a corresponding completed look-ahead window.

Example 12 provides the one or more non-transitory computer-readable media of any one of examples 1-11, where the operations further include extracting one or more further statistics from one or more further encoded frames of the group-of-pictures generated from the encoding pass; determining a further temporal correlation class for the group-of-pictures based on the one or more further statistics; and refining one or more of the bit allocation and the relative QP value based on the temporal correlation class and the further temporal correlation class.

Example 13 provides the one or more non-transitory computer-readable media of example 12, where refining one or more of the bit allocation and the relative QP value based on the temporal correlation class and the further temporal correlation class includes, based on the temporal correlation class and the further temporal correlation class being different, updating one or more of the bit allocation and the relative QP value based on the further temporal correlation class.

Example 14 provides the one or more non-transitory computer-readable media of example 12 or 13, where refining one or more of the bit allocation and the relative QP value based on the temporal correlation class and the further temporal correlation class includes, based on the temporal correlation class and the further temporal correlation class being the same, changing one or more of the bit allocation and the relative QP value based on a comparison between an actual encoding QP of the one or more further encoded frames and a look-ahead QP.

Example 15 provides the one or more non-transitory computer-readable media of example 14, where changing the bit allocation includes one or more of: increasing a bit allocation ratio between layers of the group-of-pictures based on the actual encoding QP being larger than the look-ahead QP; decreasing the bit allocation ratio between the layers of the group-of-pictures based on the actual encoding QP being smaller than the look-ahead QP; and maintaining the bit allocation ratio between the layers of the group-of-pictures based on the actual encoding QP being the same as the look-ahead QP.

Example 16 provides the one or more non-transitory computer-readable media of example 14 or 15, where changing the relative QP value includes one or more of: increasing a magnitude of the relative QP value between layers of the group-of-pictures based on the actual encoding QP being larger than the look-ahead QP; decreasing the magnitude of the relative QP value between the layers of the group-of-pictures based on the actual encoding QP being smaller than the look-ahead QP; and maintaining the magnitude of the relative QP value between the layers of the group-of-pictures based on the actual encoding QP being the same as the look-ahead QP.

Example 17 provides a computer-implemented system, including one or more processors, and one or more non-transitory computer-readable media storing instructions that, when executed by the one or more processors, cause the one or more processors to perform operations including: triggering an encoder to perform a look-ahead encoding pass on a plurality of video frames using a look-ahead quantization parameter (QP); deriving, from a plurality of encoded frames generated from the look-ahead encoding pass, one or more statistics; determining a temporal correlation class for a group-of-pictures in the look-ahead encoding pass based on the one or more statistics; determining one or more of a bit allocation and a relative QP value for one or more frames of the group-of-pictures based on the temporal correlation class; and triggering the encoder to perform an encoding pass to encode the one or more frames of the group-of-pictures using one or more of the bit allocation and the relative QP value.

Example 18 provides the computer-implemented system of example 17, where the operations further include determining the look-ahead QP based on one or more of a compression ratio and a resolution associated with the plurality of video frames.

Example 19 provides the computer-implemented system of example 18, where determining the look-ahead QP includes indexing a look-up table using one or more of a compression ratio index and a resolution index.

Example 20 provides the computer-implemented system of any one of examples 17-19, where the one or more statistics include one or more of: a frame-size related statistic, an intra-coded block statistic, and a skip-coded block statistic.

Example 21 provides the computer-implemented system of any one of examples 17-20, where determining the temporal correlation class includes assigning the temporal correlation class based on a frame size of an anchor frame of the group-of-pictures, and one or more of an average frame size of the group-of-pictures and a maximum frame size of the group-of-pictures.

Example 22 provides the computer-implemented system of any one of examples 17-21, where determining the temporal correlation class includes assigning the temporal correlation class based on an intra percentage, a skip percentage, and one or more threshold pairs associated with one or more candidate temporal correlation classes.

Example 23 provides the computer-implemented system of any one of examples 17-22, where determining the bit allocation includes retrieving, from a table indexed by the temporal correlation class, one or more adjustment ratios for the one or more frames of the group-of-pictures; and calculating adjusted bit allocations using the one or more adjustment ratios.

Example 24 provides the computer-implemented system of any one of examples 17-23, where determining the relative QP value includes retrieving, from a table indexed by the temporal correlation class, a recommended relative QP value for the one or more frames of the group-of-pictures; and calculating respective QPs for the one or more frames of the group-of-pictures using the recommended relative QP value.

Example 25 provides the computer-implemented system of any one of examples 17-24, where the operations further include determining one or more of a minimum QP and a maximum QP for the encoding pass based on an estimated encoding QP.

Example 26 provides the computer-implemented system of example 25, where the estimated encoding QP is generated by applying a machine-learning model on one or more input features associated with the plurality of encoded frames generated from the look-ahead encoding pass; and the one or more input features include one or more of: average encoded bits, average syntax bits, average skip percentage, average intra percentage, average peak signal-to-noise ratio, or average target frame size.

Example 27 provides the computer-implemented system of any one of examples 17-26, where the operations further include determining a minimum QP and a maximum QP based on an offset to an estimated encoding QP, where the offset is based on a difference between an average QP used in a completed encoding window and an average estimated QP for a corresponding completed look-ahead window.

Example 28 provides the computer-implemented system of any one of examples 17-27, where the operations further include extracting one or more further statistics from one or more further encoded frames of the group-of-pictures generated from the encoding pass; determining a further temporal correlation class for the group-of-pictures based on the one or more further statistics; and refining one or more of the bit allocation and the relative QP value based on the temporal correlation class and the further temporal correlation class.

Example 29 provides the computer-implemented system of example 28, where refining one or more of the bit allocation and the relative QP value based on the temporal correlation class and the further temporal correlation class includes, based on the temporal correlation class and the further temporal correlation class being different, updating one or more of the bit allocation and the relative QP value based on the further temporal correlation class.

Example 30 provides the computer-implemented system of example 28 or 29, where refining one or more of the bit allocation and the relative QP value based on the temporal correlation class and the further temporal correlation class includes, based on the temporal correlation class and the further temporal correlation class being the same, changing one or more of the bit allocation and the relative QP value based on a comparison between an actual encoding QP of the one or more further encoded frames and a look-ahead QP.

Example 31 provides the computer-implemented system of example 30, where changing the bit allocation includes one or more of: increasing a bit allocation ratio between layers of the group-of-pictures based on the actual encoding QP being larger than the look-ahead QP; decreasing the bit allocation ratio between the layers of the group-of-pictures based on the actual encoding QP being smaller than the look-ahead QP; and maintaining the bit allocation ratio between the layers of the group-of-pictures based on the actual encoding QP being the same as the look-ahead QP.

Example 32 provides the computer-implemented system of example 30 or 31, where changing the relative QP value includes one or more of: increasing a magnitude of the relative QP value between layers of the group-of-pictures based on the actual encoding QP being larger than the look-ahead QP; decreasing the magnitude of the relative QP value between the layers of the group-of-pictures based on the actual encoding QP being smaller than the look-ahead QP; and maintaining the magnitude of the relative QP value between the layers of the group-of-pictures based on the actual encoding QP being the same as the look-ahead QP.

Example 33 provides a computer-implemented method, including triggering an encoder to perform a look-ahead encoding pass on a plurality of video frames using a look-ahead quantization parameter (QP); deriving, from a plurality of encoded frames generated from the look-ahead encoding pass, one or more statistics; determining a temporal correlation class for a group-of-pictures in the look-ahead encoding pass based on the one or more statistics; determining one or more of a bit allocation and a relative QP value for one or more frames of the group-of-pictures based on the temporal correlation class; and triggering the encoder to perform an encoding pass to encode the one or more frames of the group-of-pictures using one or more of the bit allocation and the relative QP value.

Example 34 provides the computer-implemented method of example 33, further including determining the look-ahead QP based on one or more of a compression ratio and a resolution associated with the plurality of video frames.

Example 35 provides the computer-implemented method of example 34, where determining the look-ahead QP includes indexing a look-up table using one or more of a compression ratio index and a resolution index.

Example 36 provides the computer-implemented method of any one of examples 33-35, where the one or more statistics include one or more of: a frame-size related statistic, an intra-coded block statistic, and a skip-coded block statistic.

Example 37 provides the computer-implemented method of any one of examples 33-36, where determining the temporal correlation class includes assigning the temporal correlation class based on a frame size of an anchor frame of the group-of-pictures, and one or more of an average frame size of the group-of-pictures and a maximum frame size of the group-of-pictures.

Example 38 provides the computer-implemented method of any one of examples 33-37, where determining the temporal correlation class includes assigning the temporal correlation class based on an intra percentage, a skip percentage, and one or more threshold pairs associated with one or more candidate temporal correlation classes.

Example 39 provides the computer-implemented method of any one of examples 33-38, where determining the bit allocation includes retrieving, from a table indexed by the temporal correlation class, one or more adjustment ratios for the one or more frames of the group-of-pictures; and calculating adjusted bit allocations using the one or more adjustment ratios.

Example 40 provides the computer-implemented method of any one of examples 33-39, where determining the relative QP value includes retrieving, from a table indexed by the temporal correlation class, a recommended relative QP value for the one or more frames of the group-of-pictures; and calculating respective QPs for the one or more frames of the group-of-pictures using the recommended relative QP value.

Example 41 provides the computer-implemented method of any one of examples 33-40, further including determining one or more of a minimum QP and a maximum QP for the encoding pass based on an estimated encoding QP.

Example 42 provides the computer-implemented method of example 41, where the estimated encoding QP is generated by applying a machine-learning model on one or more input features associated with the plurality of encoded frames generated from the look-ahead encoding pass; and the one or more input features include one or more of: average encoded bits, average syntax bits, average skip percentage, average intra percentage, average peak signal-to-noise ratio, or average target frame size.

Example 43 provides the computer-implemented method of any one of examples 33-42, further including determining a minimum QP and a maximum QP based on an offset to an estimated encoding QP, where the offset is based on a difference between an average QP used in a completed encoding window and an average estimated QP for a corresponding completed look-ahead window.

Example 44 provides the computer-implemented method of any one of examples 33-43, further including extracting one or more further statistics from one or more further encoded frames of the group-of-pictures generated from the encoding pass; determining a further temporal correlation class for the group-of-pictures based on the one or more further statistics; and refining one or more of the bit allocation and the relative QP value based on the temporal correlation class and the further temporal correlation class.

Example 45 provides the computer-implemented method of example 44, where refining one or more of the bit allocation and the relative QP value based on the temporal correlation class and the further temporal correlation class includes, based on the temporal correlation class and the further temporal correlation class being different, updating one or more of the bit allocation and the relative QP value based on the further temporal correlation class.

Example 46 provides the computer-implemented method of example 44 or 45, where refining one or more of the bit allocation and the relative QP value based on the temporal correlation class and the further temporal correlation class includes, based on the temporal correlation class and the further temporal correlation class being the same, changing one or more of the bit allocation and the relative QP value based on a comparison between an actual encoding QP of the one or more further encoded frames and a look-ahead QP.

Example 47 provides the computer-implemented method of example 46, where changing the bit allocation includes one or more of: increasing a bit allocation ratio between layers of the group-of-pictures based on the actual encoding QP being larger than the look-ahead QP; decreasing the bit allocation ratio between the layers of the group-of-pictures based on the actual encoding QP being smaller than the look-ahead QP; and maintaining the bit allocation ratio between the layers of the group-of-pictures based on the actual encoding QP being the same as the look-ahead QP.

Example 48 provides the computer-implemented method of example 46 or 47, where changing the relative QP value includes one or more of: increasing a magnitude of the relative QP value between layers of the group-of-pictures based on the actual encoding QP being larger than the look-ahead QP; decreasing the magnitude of the relative QP value between the layers of the group-of-pictures based on the actual encoding QP being smaller than the look-ahead QP; and maintaining the magnitude of the relative QP value between the layers of the group-of-pictures based on the actual encoding QP being the same as the look-ahead QP.

Example A provides a rate control component (e.g., rate control 296) as described and illustrated herein.

Example B provides a rate control component (e.g., rate control 296) and an encoder (e.g., encoder 102) as described and illustrated herein.

### VARIATIONS AND REMARKS

The rate-control techniques illustrated in FIGS. 1-16 are codec-agnostic and can be applied to any video encoder that performs, or can be modified to perform, rate-control decisions based on frame-level or group-of-pictures-level statistics, including both standards-compliant and proprietary encoders. For example, the techniques may be used with encoders implementing International Telecommunication Union Telecommunication Standardization Sector Recommendation H.261, Video codec for audiovisual services at p×64 kbit/s, latest in-force version March 1993; H.263, Video coding for low bit rate communication, latest in-force version January 2005; International Organization for Standardization/International Electrotechnical Commission 13818-2:2013/H.262, Generic coding of moving pictures and associated audio information Part 2: Video, publication date October 2013; International Organization for Standardization/International Electrotechnical Commission 14496-2:2004, Coding of audio-visual objects Part 2: Visual; International Telecommunication Union Telecommunication Standardization Sector Recommendation H.264/International Organization for Standardization/International Electrotechnical Commission 14496-10:2025, Advanced video coding, publication date July 2025; H.265/International Organization for Standardization/International Electrotechnical Commission 23008-2:2025, High efficiency video coding, publication date March 2025; H.266/International Organization for Standardization/International Electrotechnical Commission 23090-3:2024, Versatile video coding, publication date July 2024, with the International Telecommunication Union listing H.266 version January 2026 as in force; Alliance for Open Media Video 1, AV1 Bitstream & Decoding Process Specification, last modified May 25, 2023; Alliance for Open Media Video 2, AV2 Bitstream & Decoding Process Specification, Working Group Approved Draft dated Jan. 5, 2026; VP8 as described in Request for Comments 6386, VP8 Data Format and Decoding Guide, November 2011; VP9 as described by the WebM Project's VP9 Video Codec materials, last modified Oct. 16, 2023; and other present or future block-based, hybrid, predictive, transform-based, neural-assisted, real-time, offline, hardware, software, cloud, client-side, or embedded video encoders. The applicability does not depend on a particular syntax element of any one standard. Rather, the techniques operate at the encoder-control layer by selecting a look-ahead quantization parameter, deriving statistics from encoded frames, determining a temporal correlation class for a group-of-pictures, selecting bit allocation and relative QP values, constraining actual encoding QP using minimum and maximum QP values, and refining those decisions based on actual encoding feedback.

One or more functionalities of rate control 296 and encoder 102 can be implemented as software instructions encoded in non-transitory computer-readable media, hardware logic or circuits, or both.

Although the operations of the example method shown in and described with reference to FIGS. 1-16 are illustrated as occurring once each and in a particular order, it will be recognized that some operations may be performed in any suitable order and repeated as desired. Additionally, one or more operations may be performed in parallel. Furthermore, the operations illustrated in FIGS. 1-16 may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second threshold are set in a manner so that both statements result in the same logical outcome for any value of A. For the purposes of the present disclosure, “B is greater than a first threshold” is equivalent to “B is greater than or equal to a second threshold” provided that the first threshold and the second threshold are set in a manner so that both statements result in the same logical outcome for any value of B.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. One or more non-transitory computer-readable media storing instructions that, when executed by one or more processors, cause the one or more processors to perform operations comprising:
triggering an encoder to perform a look-ahead encoding pass on a plurality of video frames using a look-ahead quantization parameter (QP);
deriving, from a plurality of encoded frames generated from the look-ahead encoding pass, one or more statistics;
determining a temporal correlation class for a group-of-pictures in the look-ahead encoding pass based on the one or more statistics;
determining one or more of a bit allocation and a relative QP value for one or more frames of the group-of-pictures based on the temporal correlation class; and
triggering the encoder to perform an encoding pass to encode the one or more frames of the group-of-pictures using one or more of the bit allocation and the relative QP value.

2. The one or more non-transitory computer-readable media of claim 1, wherein the operations further include:
determining the look-ahead QP based on one or more of a compression ratio and a resolution associated with the plurality of video frames.

3. The one or more non-transitory computer-readable media of claim 2, wherein determining the look-ahead QP comprises indexing a look-up table using one or more of a compression ratio index and a resolution index.

4. The one or more non-transitory computer-readable media of claim 1, wherein the one or more statistics comprise one or more of: a frame-size related statistic, an intra-coded block statistic, and a skip-coded block statistic.

5. The one or more non-transitory computer-readable media of claim 1, wherein determining the temporal correlation class comprises:
assigning the temporal correlation class based on a frame size of an anchor frame of the group-of-pictures, and one or more of an average frame size of the group-of-pictures and a maximum frame size of the group-of-pictures.

6. The one or more non-transitory computer-readable media of claim 1, wherein determining the temporal correlation class comprises:
assigning the temporal correlation class based on an intra percentage, a skip percentage, and one or more threshold pairs associated with one or more candidate temporal correlation classes.

7. The one or more non-transitory computer-readable media of claim 1, wherein determining the bit allocation comprises:
retrieving, from a table indexed by the temporal correlation class, one or more adjustment ratios for the one or more frames of the group-of-pictures; and
calculating adjusted bit allocations using the one or more adjustment ratios.

8. The one or more non-transitory computer-readable media of claim 1, wherein determining the relative QP value comprises:
retrieving, from a table indexed by the temporal correlation class, a recommended relative QP value for the one or more frames of the group-of-pictures; and
calculating respective QPs for the one or more frames of the group-of-pictures using the recommended relative QP value.

9. The one or more non-transitory computer-readable media of claim 1, wherein the operations further comprise:
determining one or more of a minimum QP and a maximum QP for the encoding pass based on an estimated encoding QP.

10. The one or more non-transitory computer-readable media of claim 9, wherein:
the estimated encoding QP is generated by applying a machine-learning model on one or more input features associated with the plurality of encoded frames generated from the look-ahead encoding pass; and
the one or more input features comprise one or more of: average encoded bits, average syntax bits, average skip percentage, average intra percentage, average peak signal-to-noise ratio, or average target frame size.

11. The one or more non-transitory computer-readable media of claim 1, wherein the operations further comprise:
determining a minimum QP and a maximum QP based on an offset to an estimated encoding QP, wherein the offset is based on a difference between an average QP used in a completed encoding window and an average estimated QP for a corresponding completed look-ahead window.

12. The one or more non-transitory computer-readable media of claim 1, wherein the operations further comprise:
extracting one or more further statistics from one or more further encoded frames of the group-of-pictures generated from the encoding pass;
determining a further temporal correlation class for the group-of-pictures based on the one or more further statistics; and
refining one or more of the bit allocation and the relative QP value based on the temporal correlation class and the further temporal correlation class.

13. The one or more non-transitory computer-readable media of claim 12, wherein refining one or more of the bit allocation and the relative QP value based on the temporal correlation class and the further temporal correlation class comprises:
based on the temporal correlation class and the further temporal correlation class being different, updating one or more of the bit allocation and the relative QP value based on the further temporal correlation class.

14. The one or more non-transitory computer-readable media of claim 12, wherein refining one or more of the bit allocation and the relative QP value based on the temporal correlation class and the further temporal correlation class comprises:
based on the temporal correlation class and the further temporal correlation class being the same, changing one or more of the bit allocation and the relative QP value based on a comparison between an actual encoding QP of the one or more further encoded frames and a look-ahead QP.

15. The one or more non-transitory computer-readable media of claim 14, wherein changing the bit allocation comprises one or more of:
increasing a bit allocation ratio between layers of the group-of-pictures based on the actual encoding QP being larger than the look-ahead QP;
decreasing the bit allocation ratio between the layers of the group-of-pictures based on the actual encoding QP being smaller than the look-ahead QP; and
maintaining the bit allocation ratio between the layers of the group-of-pictures based on the actual encoding QP being the same as the look-ahead QP.

16. The one or more non-transitory computer-readable media of claim 14, wherein changing the relative QP value comprises one or more of:
increasing a magnitude of the relative QP value between layers of the group-of-pictures based on the actual encoding QP being larger than the look-ahead QP;
decreasing the magnitude of the relative QP value between the layers of the group-of-pictures based on the actual encoding QP being smaller than the look-ahead QP; and
maintaining the magnitude of the relative QP value between the layers of the group-of-pictures based on the actual encoding QP being the same as the look-ahead QP.

17. A computer-implemented system, comprising one or more processors, and one or more non-transitory computer-readable media storing instructions that, when executed by the one or more processors, cause the one or more processors to perform operations comprising:
triggering an encoder to perform a look-ahead encoding pass on a plurality of video frames using a look-ahead quantization parameter (QP);
deriving, from a plurality of encoded frames generated from the look-ahead encoding pass, one or more statistics;
determining a temporal correlation class for a group-of-pictures in the look-ahead encoding pass based on the one or more statistics;
determining one or more of a bit allocation and a relative QP value for one or more frames of the group-of-pictures based on the temporal correlation class; and
triggering the encoder to perform an encoding pass to encode the one or more frames of the group-of-pictures using one or more of the bit allocation and the relative QP value.

18. The computer-implemented system of claim 17, wherein the operations further include:
determining the look-ahead QP based on one or more of a compression ratio and a resolution associated with the plurality of video frames.

19. A computer-implemented method, comprising:
triggering an encoder to perform a look-ahead encoding pass on a plurality of video frames using a look-ahead quantization parameter (QP);
deriving, from a plurality of encoded frames generated from the look-ahead encoding pass, one or more statistics;
determining a temporal correlation class for a group-of-pictures in the look-ahead encoding pass based on the one or more statistics;
determining one or more of a bit allocation and a relative QP value for one or more frames of the group-of-pictures based on the temporal correlation class; and
triggering the encoder to perform an encoding pass to encode the one or more frames of the group-of-pictures using one or more of the bit allocation and the relative QP value.

20. The computer-implemented method of claim 19, further comprising:
extracting one or more further statistics from one or more further encoded frames of the group-of-pictures generated from the encoding pass;
determining a further temporal correlation class for the group-of-pictures based on the one or more further statistics; and
refining one or more of the bit allocation and the relative QP value based on the temporal correlation class and the further temporal correlation class.
